(19) United States
(12) Patent Application Publication
(10) Pub. No.: US 2024/0419396 A1
(43) Pub. Date: Dec. 19, 2024

(54) SONG PLAYING METHOD AND APPARATUS, COMPUTER DEVICE, AND COMPUTER-READABLE STORAGE MEDIUM

(71) Applicant: Tencent Technology (Shenzhen) Company Limited, Shenzhen (CN)

(72) Inventors: Han TANG, Shenzhen (CN); Yana HUANG, Shenzhen (CN); Muni LIU, Shenzhen (CN); Lingfang PANG, Shenzhen (CN); Kai ZHANG, Shenzhen (CN); Qian CHEN, Shenzhen (CN); Wenxing XU, Shenzhen (CN); Bin JIANG, Shenzhen (CN); Huangui HUI, Shenzhen (CN); Tianzuo YU, Shenzhen (CN); Yonghui TONG, Shenzhen (CN); Shaopeng YU, Shenzhen (CN); Shuimiao LI, Shenzhen (CN)

(73) Assignee: Tencent Technology (Shenzhen) Company Limited, Shenzhen (CN)

(21) Appl. No.: 18/815,481

(22) Filed: Aug. 26, 2024

Related U.S. Application Data
(63) Continuation of application No. PCT/CN2023/089983, filed on Apr. 23, 2023.

(30) Foreign Application Priority Data
Jun. 30, 2022 (CN) 202210760923.1

(51) Int. Cl. G06F 3/16; G06V 40/16

(52) U.S. Cl. CPC G06F 3/165; G06V 40/171

(57) ABSTRACT

A song playing method includes: playing an original vocal of a target song in a song listening mode; reducing a volume of the original vocal in response to a first continuous following behavior for the target song, the first continuous following behavior being a continuous following behavior made with playing progress of the target song; switching from the song listening mode to a song singing mode in response to a second continuous following behavior after the first continuous following behavior, the second continuous following behavior being different from the first continuous following behavior, and being a continuous following behavior that is made with the playing progress of the target song and is generated after the first continuous following behavior; and playing, in the song singing mode, a song accompaniment of the target song from song progress of the target song that is indicated by the original vocal.

### RELATED APPLICATION

This application claims priority as a Continuation to PCT/CN2023/089983 filed on Apr. 23, 2023, which claims priority to Chinese Patent Application No. 202210760923.1, entitled “SONG PLAYING METHOD AND APPARATUS, COMPUTER DEVICE, AND COMPUTER-READABLE STORAGE MEDIUM” and filed with the China National Intellectual Property Administration on Jun. 30, 2022, both of which are incorporated herein by reference.

### FIELD OF THE TECHNOLOGY

This application relates to the field of computer technologies, and in particular, to a song playing method and apparatus, a computer device, a computer-readable storage medium, and a computer program product.

### BACKGROUND OF THE DISCLOSURE

With the development of computer technologies, functions of terminals are becoming more comprehensive. For example, a music application in the terminal may use a song listening mode and a song singing mode. In the song listening mode, a user can listen to various music, while in the song singing mode, the user can sing a song without being limited by the venue, so that the user can enjoy the music anytime and anywhere.

However, in a current song playing mode, a song listening mode and a song singing mode of the song need to be manually switched, and the song needs to be replayed after switching, which has a problem of inflexible song playing.

### SUMMARY

According to various exemplary embodiments provided in this disclosure, a song playing method and apparatus, a computer device, a computer-readable storage medium, and a computer program product that can flexibly switch a song mode are provided.

This disclosure provides a song playing method, performed by a terminal. The method includes:
playing an original vocal of a target song in a song listening mode;
reducing a volume of the original vocal in response to a first continuous following behavior for the target song, the first continuous following behavior being a continuous following behavior made with playing progress of the target song;
switching from the song listening mode to a song singing mode in response to a second continuous following behavior after the first continuous following behavior, the second continuous following behavior being different from the first continuous following behavior, and being a continuous following behavior that is made with the playing progress of the target song and that is generated after the first continuous following behavior; and
playing, in the song singing mode, a song accompaniment of the target song from song progress that is of the target song and that is indicated by the original vocal.

This disclosure further provides a song playing apparatus. The song playing apparatus includes:
an original vocal playing module, configured for playing, in a song listening mode, an original vocal of a target song;
an adjustment module, configured for reducing a volume of the original vocal in response to a first continuous following behavior for the target song, the first continuous following behavior being a continuous following behavior made with playing progress of the target song;
a switching module, configured for switching from the song listening mode to a song singing mode in response to a second continuous following behavior after the first continuous following behavior; and the second continuous following behavior being different from the first continuous following behavior, and being a continuous following behavior that is made with the playing progress of the target song and that is generated after the first continuous following behavior; and
an accompaniment playing module, configured for playing, in the song singing mode, a song accompaniment of the target song from song progress that is of the target song and that is indicated by the original vocal.

This disclosure further provides a computer device. The computer device includes a memory and a processor. The memory stores computer-readable instructions. The computer-readable instructions, when executed by the processor, cause the processor to perform the operations of the foregoing song playing method.

This disclosure further provides one or more non-volatile readable storage mediums storing computer-readable instructions. The computer-readable instructions, when executed by one or more processors, cause the one or more processors to perform the operations of the foregoing song playing method.

This disclosure further provides a computer program product, including computer-readable instructions. The computer-readable instructions, when executed by one or more processors, cause the one or more processors to perform the operations of the foregoing song playing method.

Details of one or more exemplary embodiments of this disclosure are provided in the accompanying drawings and descriptions below. Other features, objectives, and advantages of this disclosure become apparent from the specification, the accompanying drawings, and the claims.

### BRIEF DESCRIPTION OF THE DRAWINGS

To describe the technical solutions in the exemplary embodiments of this disclosure or in the related art more clearly, the following briefly introduces the accompanying drawings that need to be used for describing the exemplary embodiments or the related art. Apparently, the accompanying drawings in the following description show merely some exemplary embodiments of this disclosure, and a person of ordinary skill in the art may still derive accompanying drawings of other embodiments from the accompanying drawings without creative efforts.

FIG. 1 is a diagram of an application environment of a song playing method according to an exemplary embodiment.

FIG. 2 is a schematic flowchart of a song playing method according to an exemplary embodiment.

FIG. 3 is a schematic flowchart of playing an original vocal according to an exemplary embodiment.

FIG. 4 is a schematic flowchart of playing a song accompaniment according to an exemplary embodiment.

FIG. 5 is a schematic flowchart of displaying prompt information indicating that no song accompaniment exists according to an exemplary embodiment.

FIG. 6 is a schematic diagram of a lyrics display interface in a song listening mode according to an exemplary embodiment.

FIG. 7 is a schematic diagram of a lyrics display interface in a song singing mode according to an exemplary embodiment.

FIG. 8 is a sequence diagram of a song playing method according to an exemplary embodiment.

FIG. 9 is a schematic diagram of an architecture of a song playing method according to an exemplary embodiment.

FIG. 10 is a schematic diagram of interaction in a song playing method according to an exemplary embodiment.

FIG. 11 is a schematic diagram of interaction in a song playing method according to another exemplary embodiment.

FIG. 12 is a schematic flowchart of switching to a song singing mode according to an exemplary embodiment.

FIG. 13 is a schematic flowchart of playing a song accompaniment according to an exemplary embodiment.

FIG. 14 is a block diagram of a structure of a song playing apparatus according to an exemplary embodiment.

FIG. 15 is a diagram of an internal structure of a computer device according to an exemplary embodiment.

### DESCRIPTION OF EMBODIMENTS

To make the objectives, technical solutions, and advantages of this application clearer, the following further describes this application in detail with reference to the accompanying drawings and the exemplary embodiments. The specific embodiments described herein are merely used for explaining this application, and are not used for limiting this application.

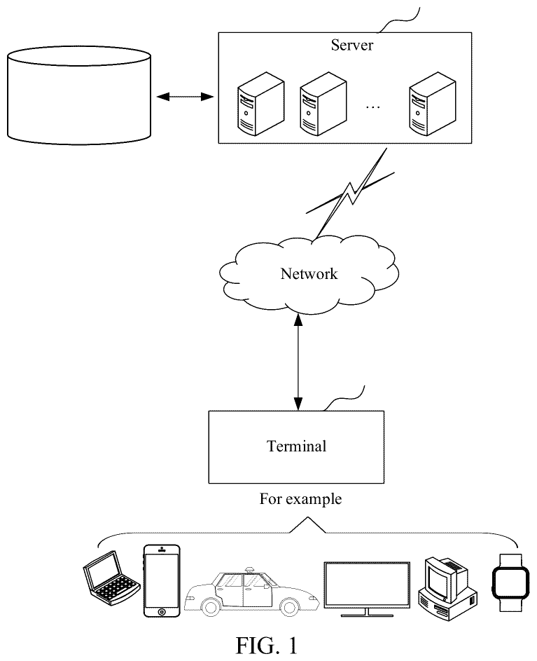

A song playing method provided in exemplary embodiments of this disclosure may be applied to an application environment shown in FIG. 1. A terminal 102 communicates with a server 104 by using a network. A data storage system may store data that the server 104 needs to process. The data storage system may be integrated on the server 104, or may be placed on the cloud or another server. The terminal 102 may separately perform the song playing method provided in the exemplary embodiments of this disclosure. The terminal 102 and the server 104 may alternatively be collaboratively configured for performing the song playing method provided in the exemplary embodiments of this disclosure. When the terminal 102 and the server 104 are collaboratively configured for performing the song playing method provided in the exemplary embodiments of this disclosure, the terminal 102 obtains a target song from the server 104, and the terminal 102 plays an original vocal of the target song in a song listening mode. The terminal 102 reduces a volume of the original vocal in response to a first continuous following behavior for the target song. The first continuous following behavior is a continuous following behavior made with playing progress of the target song. The terminal 102 switches from the song listening mode to a song singing mode in response to a second continuous following behavior after the first continuous following behavior. The second continuous following behavior is different from the first continuous following behavior, and is a continuous following behavior that is made with the playing progress of the target song and that is generated after the first continuous following behavior. In the song singing mode, the terminal 102 plays a song accompaniment of the target song from song progress that is of the target song and that is indicated by the original vocal.

The terminal 102 may be but is not limited to any personal computer, notebook computer, smartphone, tablet computer, intelligent voice interaction device, smart home appliance, in-vehicle terminal, flight vehicle, portable wearable device, and the like. The server 104 may be an independent physical server, may be a server cluster including a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal 102 and the server 104 may be directly or indirectly connected in a wired or wireless communication protocol. This is not limited in this disclosure.

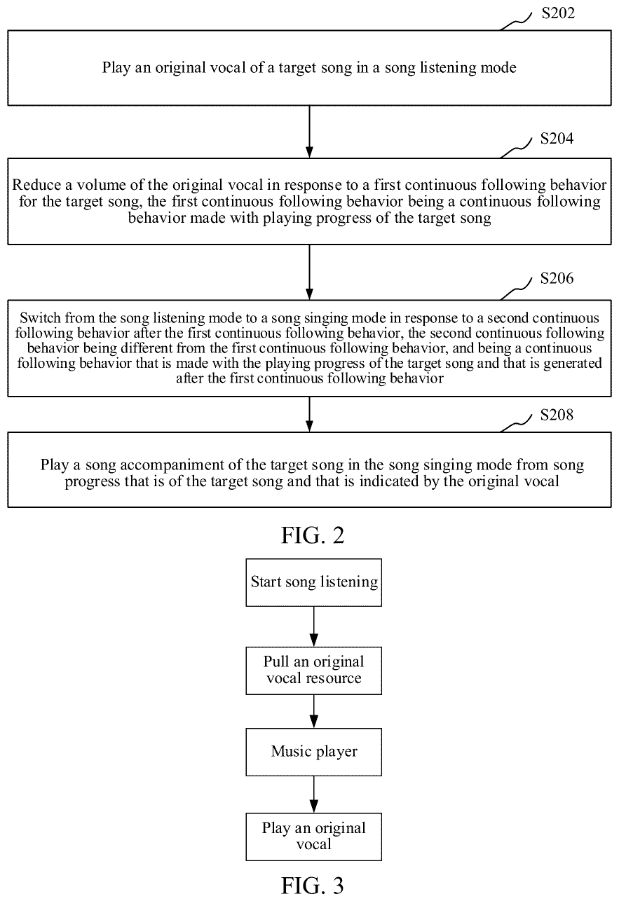

In an exemplary embodiment, as shown in FIG. 2, a song playing method is provided. The method is applied to the terminal shown in FIG. 1 as an example for description. The method includes the following operations:

Operation S202: Play an original vocal of a target song in a song listening mode.

The song refers to a voiced work formed by combining a melody, a person's voice, and lyrics, and is an expression form combining the lyrics and music scores. The lyrics one-to-one correspond to the music scores. The target song is a song specified to be played by a user. The target song includes an original vocal and a song accompaniment. The original vocal refers to a song singed by a human voice. In other exemplary embodiments, the original vocal may be a song whose songwriter is first published by a singer and that is singed by the singer or a cooperative. The song accompaniment refers to instrumental music performance that accompanies singing. For vocal music, a part other than the vocal is referred to as the song accompaniment. The song accompaniment is consistent with a singing tune of the human voice.

The song is played through a music application. The music application is an application having a music playing function. The music application may be presented to a user in a form of an application program, and the user may play a song through the application program. The application program may refer to a client installed in the terminal. The application program may alternatively be an installation-free application program, that is, an application program that can be used without downloading and installing. Such an application program may also be referred to as an applet, which is usually run as a subprogram in a client. In this case, the client is referred to as a parent application, and the subprogram running in the client is referred to as a child application. The application program may alternatively be a web application program opened through a browser, or the like.

The music application may play a song in different song modes. The song mode is a playing mode of the song, and includes a song listening mode, a song singing mode, and the like. The song singing mode is a mode in which the song accompaniment is played but the original vocal is not played, to perform song singing in combination with the song accompaniment. The song listening mode is a mode of playing the original vocal. In another exemplary embodiment, the song listening mode may be a mode of playing the target song including the original vocal and the song accompaniment.

The music application may alternatively be a cloud music application. The cloud music application is a music application running in the cloud. The cloud music application is an application in which the terminal interacts with the cloud. A running manner of the cloud music application is encoding, through a strong computing capability of a cloud simulator, running processes into audio and video streams, which are transmitted to the terminal through a network and played and displayed through the cloud music application, to implement interaction with a user.

The server is on the cloud side, also referred to as a cloud server. The cloud server is a service that integrates computer resources by using a virtualization technology based on a large-scale distributed computing system to provide an Internet infrastructure. A network that provides the resources is referred to as a “cloud”. The resources in the “cloud” seem to be infinitely expandable to a user, and can be obtained at any time, used on demand, expanded at any time, and paid for based on use. Cloud computing (cloud computing) is a computing mode that distributes computing tasks in a resource pool formed by a large quantity of computers, so that various application systems can obtain computing power, storage space, and information services as required. The cloud server may include a music player and an accompaniment server, and may further include a speech recognition server, but is not limited thereto.

Specifically, the music application having a song playing function may be run on the terminal. The music application plays a song in the song listening mode, and a currently playing song may be used as the target song. The target song includes an original vocal and a song accompaniment.

In this exemplary embodiment, the user selects a song in the music application, and plays the selected target song in the song listening mode. The terminal determines, in response to the selection operation on the song by the user, the target song selected by the selection operation, and plays the target song in the song listening mode.

In an exemplary embodiment, the terminal may determine, in response to the selection operation on the song by the user, the target song selected by the selection operation, obtain the target song and corresponding lyrics from a music server corresponding to the music application, play the target song in target song listening mode, and display the lyrics corresponding to the target song.

In an exemplary embodiment, the terminal may play the original vocal of the target song in the song listening mode, and display the lyrics corresponding to the target song.

FIG. 3 is a schematic flowchart of playing an original vocal according to an exemplary embodiment. A user starts a music application, loads an audio stream resource corresponding to an original vocal of a target song through the music application, and decodes the audio stream resource through a music player corresponding to the music application and plays the audio stream resource.

Operation S204: Reduce a volume of the original vocal in response to a first continuous following behavior for the target song. The first continuous following behavior is a continuous following behavior made with playing progress of the target song.

The first continuous following behavior is a continuous following behavior of a target object for the target song, including but not limited to at least one of a first continuous mouth shape following behavior, a first continuous voice following behavior, or a first continuous body following behavior. The first continuous mouth shape following behavior is a continuous following behavior for a mouth shape of the lyrics of the target song. The first continuous voice following behavior is a continuous following behavior for a melody of the target song. The first continuous body following behavior is a continuous following behavior for a body behavior of a singing object of the target song when the singing object sings the target song. The singing object is a singer of the target song.

Specifically, the user may follow the target song. When detecting a continuous following behavior made by the user with the playing progress of the target song, the terminal uses the continuous following behavior as the first continuous following behavior. The terminal reduces a current playing volume of the original vocal in response to the first continuous following behavior for the target song.

Further, when detecting at least one of the first continuous mouth shape following behavior, the first continuous voice following behavior, or the first continuous body following behavior for the target song, the terminal reduces the volume of the original vocal in response to the at least one of the first continuous mouth shape following behavior, the first continuous voice following behavior, or the first continuous body following behavior for the target song.

In this exemplary embodiment, in response to the first continuous following behavior for the target song, the volume of the original vocal of the target song is reduced, and a volume of the song accompaniment is maintained.

In this exemplary embodiment, the terminal may perform object recognition in the song listening mode. When the target object exists in the computer vision field of view, and the target object has at least one of the first continuous mouth shape following behavior, the first continuous voice following behavior, or the first continuous body following behavior for the target song, the terminal reduces the volume of the original vocal in response to the at least one of the first continuous mouth shape following behavior, the first continuous voice following behavior, or the first continuous body following behavior for the target song. Computer vision (Computer Vision) is machine vision that recognizes and measures a target by using a computer device instead of a human eye. The computer vision is a general term related to calculation of any visual content, including calculation of any content related to an image, a video, an icon, and a pixel. The computer vision field of view refers to a spatial range that can be observed by the computer device. The computer device is, for example, any device carrying a camera.

Operation S206: Switch from the song listening mode to the song singing mode in response to a second continuous following behavior after the first continuous following behavior. The second continuous following behavior is different from the first continuous following behavior, and is a continuous following behavior that is made with the playing progress of the target song and that is generated after the first continuous following behavior.

The second continuous following behavior is a continuous following behavior that is for the target song and that is performed after the first continuous following behavior. The second continuous following behavior includes, but is not limited to, at least one of a second continuous mouth shape following behavior, a second continuous voice following behavior, or a second continuous body following behavior. The second continuous mouth shape following behavior is a continuous following behavior that is for a mouth shape of the lyrics of the target song and that is after the first continuous mouth shape following behavior. The second continuous voice following behavior is a continuous following behavior that is for a melody of the target song and that is generated after the first continuous voice following behavior. The second continuous body following behavior is a continuous following behavior that is for a body behavior of a singing object of the target song when the singing object sings the target song and that is generated after the first continuous body following behavior.

The second continuous following behavior is different from the first continuous following behavior, and the second continuous following behavior may include the first continuous following behavior. The second continuous following behavior is different from the first continuous following behavior, wherein a difference may be at least one of a different following mouth shape, a different following duration, a different following voice, or a different speech recognition text of a following voice.

Specifically, the terminal continues to perform real-time detection after the first continuous following behavior. When detecting that the user generates a continuous following behavior with the playing progress of the target song after the first continuous following behavior, the terminal uses, as the second continuous following behavior for the target song, the continuous following behavior after the first continuous following behavior. The terminal switches from the target song from the song listening mode to the song singing mode in response to the second continuous following behavior for the target song, and switches the original vocal of the target song to the song accompaniment of the target song, so that only the song accompaniment of the target song is played and the original vocal is not played.

Further, after detecting the first continuous following behavior for the target song, when detecting at least one of the second continuous mouth shape following behavior, the second continuous voice following behavior, or the second continuous body following behavior for the target song, the terminal switches, in response to the at least one of the second continuous mouth shape following behavior, the second continuous voice following behavior, or the second continuous body following behavior for the target song, the target song from the song listening mode to the song singing mode, and switches the original vocal of the target song to the song accompaniment of the target song.

In this exemplary embodiment, after the terminal detects that the target object exists in the computer vision field of view and the first continuous following behavior of the target object for the target song exists, when the target object has at least one of the second continuous mouth shape following behavior, the second continuous voice following behavior, or the second continuous body following behavior for the target song, the terminal switches the target song from the song listening mode to the song singing mode in response to the at least one of the second continuous mouth shape following behavior, the second continuous voice following behavior, or the second continuous body following behavior for the target song, and switches the original vocal of the target song to the song accompaniment of the target song.

Operation S208: Play, in the song singing mode, the song accompaniment of the target song from song progress that is of the target song and that is indicated by the original vocal.

The song progress refers to current playing progress of the target song, and may be specifically a current playing timestamp or a current playing position.

Specifically, the terminal switches from the song listening mode to the song singing mode, stops playing the original vocal, determines current song progress that is of the target song and that is indicated by the original vocal, and determines corresponding progress of the song progress in the song accompaniment. The terminal plays, in the song listening mode, the song accompaniment from the corresponding progress of the song accompaniment.

In an exemplary embodiment, the terminal may determine the song progress that is of the target song and that is indicated by the original vocal, obtain the original vocal of the target song from an accompaniment server corresponding to a music application, and determine the corresponding progress of the song progress in the song accompaniment. The terminal plays, in the song singing mode, the song accompaniment from the corresponding progress of the song accompaniment.

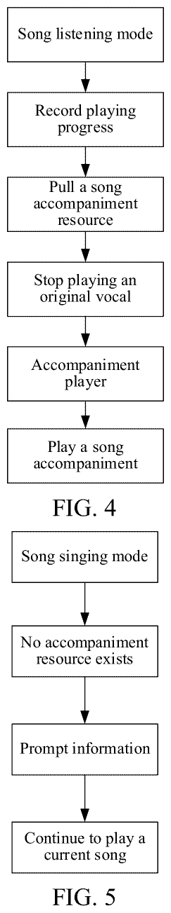

As shown in FIG. 4, an original vocal of a target song is played in a song listening mode. When a second continuous following behavior after a first continuous following behavior is detected or a user selects the song listening mode, playing progress of the original vocal at this time is recorded. A resource of a song accompaniment of the target song is loaded, the original vocal is stopped to be played, and the song accompaniment is played in a song singing mode by using an accompaniment player.

In an exemplary embodiment, the song playing method is applied to an in-vehicle terminal, and is specifically performed by a music application running on the in-vehicle terminal. The original vocal of the target song is played in the song listening mode by using a music application of the in-vehicle terminal. The music application reduces a volume of the original vocal in response to the first continuous following behavior for the target song. The music application switches from the song listening mode to the song singing mode in response to the second continuous following behavior after the first continuous following behavior. In the song singing mode, the music application plays the song accompaniment of the target song from the song progress that is of the target song and that is indicated by the original vocal.

In an exemplary embodiment, when the music application is a cloud music application, the terminal may determine, in response to a selection operation on a song by the user, a selection event triggered by the selection operation, and feed back the selection event to a cloud, and after receiving the fed back selection event, the cloud determines a target song selected by the user based on the selection event. The cloud obtains an audio stream corresponding to an original vocal of the target song, and transmits the real-time audio stream to the cloud music application for playing. The terminal feeds back, in response to a first continuous following behavior for the target song, a first continuous following event triggered by the first continuous following behavior to the cloud, and the cloud adjusts, based on the first continuous following event, a current playing volume of the original vocal, and continues to transmit the audio stream with an adjusted volume to the cloud music application for playing. The terminal feeds back, in response to the second continuous following behavior after the first continuous following behavior, a second continuous following event triggered by the second continuous following behavior to the cloud. The cloud switches, based on the second continuous following event, a song mode of the target song from the song listening mode to the song singing mode, obtains an audio stream corresponding to a song accompaniment of the target song, and transmits the audio stream corresponding to the song accompaniment to the cloud music application in real time for playing. Further, the cloud may determine song progress that is of the target song and that is indicated by the original vocal, determine corresponding progress of the song progress in the song accompaniment, and start transmitting the corresponding audio stream to the cloud music application in real time from the corresponding progress of the song accompaniment, to play the song accompaniment of the target song through the cloud music application from the song progress that is of the target song and that is indicated by the original vocal.

In this exemplary embodiment, the original vocal of the target song is played in the song listening mode, and the volume of the original vocal is reduced in response to the first continuous following behavior for the target song. An intention of the user to sing the song can be recognized based on the continuous following behavior made by the user with playing progress of the target song, to automatically reduce the volume of the original vocal, so that the continuous following behavior of the user is not covered by the original vocal. In this way, the user can hear a singing voice of the user, and this is conducive to further identification and confirmation of the continuous following behavior of the user. Switching is performed from the song listening mode to the song singing mode in response to the second continuous following behavior after the first continuous following behavior. The intention of the user to sing the song can be further confirmed based on the continuous following behavior that is made with the playing progress of the target song and that is generated by the user after the first continuous following behavior, so that the song is automatically and accurately adjusted from the song listening mode to the song singing mode, thereby achieving flexible adjustment and smooth switching of the song mode. In the song singing mode, the song accompaniment of the target song is played from the song progress that is of the target song and that is indicated by the original vocal, so that current singing progress of the original vocal can be naturally transited to corresponding accompaniment progress of the song accompaniment. In this way, a song mode can be switched at any playing progress of the song at any time and playing can be started from the same progress, making the song playing more flexible.

In an exemplary embodiment, the first continuous following behavior includes a first continuous mouth shape following behavior, and the second continuous following behavior includes a second continuous mouth shape following behavior. The reducing a volume of the original vocal in response to the first continuous following behavior for the target song includes: reducing the volume of the original vocal in the song listening mode when a target object exists in a computer vision field of view and a first continuous mouth shape following behavior for the target song exists at a mouth of the target object.

The switching from the song listening mode to a song singing mode in response to a second continuous following behavior after the first continuous following behavior includes: switching from the song listening mode to the song singing mode when the second continuous following behavior for the target song exists at the mouth of the target object after the first continuous mouth shape following behavior.

Specifically, the first continuous following behavior includes a first continuous mouth shape following behavior. In the song listening mode, the terminal may perform target object detection through a camera, and perform mouth detection on the target object through the camera when detecting that the target object exists in the computer vision field of view, to detect whether the first continuous mouth shape following behavior for the target song exists at the mouth of the target object. When the target object exists in the computer vision field of view, and the first continuous mouth shape following behavior for the target song exists at the mouth of the target object, the terminal may determine a current playing volume of the original vocal, reduce the current playing volume of the original vocal, and play the original vocal with the reduced volume.

When the target object does not exist in the computer vision field of view, the original vocal continues to be played. When the target object exists in the computer vision field of view, and no first continuous mouth shape following behavior for the target song exists at the mouth of the target object, the original vocal continues to be played.

The second continuous following behavior includes a second continuous mouth shape following behavior. After detecting that the first continuous mouth shape following behavior for the target song exists at the mouth of the target object, the terminal continues to detect the mouth of the target object through the camera. After the first continuous mouth shape following behavior for the target object is detected, when it is detected that the second continuous mouth shape following behavior for the target song exists at the mouth of the target object, the target song is switched from the song listening mode to the song singing mode, and the original vocal of the target song is switched to the song accompaniment of the target song.

After the first continuous mouth shape following behavior for the target song exists at the mouth of the target object in the computer vision field of view, but the target object does not exist in the computer vision field of view, the original vocal with the reduced volume continues to be played. After the first continuous mouth shape following behavior for the target song exists at the mouth of the target object in the computer vision field of view, and the second continuous mouth shape following behavior for the target song does not exist at the mouth of the target object, the original vocal with the reduced volume continues to be played.

In this exemplary embodiment, the terminal may perform real-time detection on the target object through the camera, reduce the volume of the original vocal when detecting that the first continuous mouth shape following behavior for the target song exists at the mouth of the target object, and continue to perform real-time detection on the target object through the camera, to detect whether the second continuous following behavior exists.

In an exemplary embodiment, interval duration between the second continuous mouth shape following behavior and the first continuous mouth shape following behavior is less than a first duration threshold. The switching from the song listening mode to the song singing mode when the second continuous following behavior for the target song exists at the mouth of the target object after the first continuous mouth shape following behavior includes:
switching, after the first continuous mouth shape following behavior, from the song listening mode to the song singing mode when the second continuous following behavior for the target song exists at the mouth of the target object and interval duration between the second continuous mouth shape following behavior and the first continuous mouth shape following behavior is less than a first duration threshold.

The first duration threshold is a critical duration value preset based on experience. The first duration threshold is used as one of conditions for whether to switch from the song listening mode to the song singing mode.

In this exemplary embodiment, the first continuous following behavior includes the first continuous mouth shape following behavior, and the second continuous following behavior includes the second continuous mouth shape following behavior, so that the volume of the original vocal can be automatically reduced based on continuous mouth shape following of the song by the user, and a song mode can be automatically switched based on a plurality of times of continuous mouth shape following. In the song listening mode, when the target object exists in the computer vision field of view, and the first continuous mouth shape following behavior for the target song exists at the mouth of the target object, it may be preliminarily determined that an intention of the user to sing along to the song exists. In this case, the volume of the original vocal is reduced, to further subsequently confirm whether the intention of the user to sing along to the song exists. After the first continuous mouth shape following behavior, when the second continuous following behavior for the target song further exists at the mouth of the target object, it is determined again that the user needs to sing the song. In this case, switching is automatically performed from the song listening mode to the song singing mode, so that the user does not need to manually adjust the song mode, thereby achieving flexible adjustment of the song mode.

In an exemplary embodiment, the first continuous following behavior includes a first continuous mouth shape following behavior, and the second continuous following behavior includes a second continuous mouth shape following behavior. The reducing a volume of the original vocal in response to the first continuous following behavior for the target song includes: recording a video in the song listening mode; and reducing the volume of the original vocal when a target object exists in the recorded video and the first continuous mouth shape following behavior for the target song exists at the mouth of the target object.

The switching from the song listening mode to a song singing mode in response to a second continuous following behavior after the first continuous following behavior includes: switching from the song listening mode to the song singing mode when the second continuous following behavior for the target song exists after the first continuous mouth shape following behavior for the target song exists at the mouth of the target object in the recorded video.

In the song listening mode, the terminal may perform real-time video recording through a camera. The volume of the original vocal is reduced when the target object exists in the recorded video and the first continuous mouth shape following behavior for the target song exists at the mouth of the target object. When the target object exists in the recorded video, the terminal may perform real-time video recording on the target object through the camera.

In an exemplary embodiment, the reducing the volume of the original vocal in the song listening mode when a target object exists in a computer vision field of view and a first continuous mouth shape following behavior for the target song exists at a mouth of the target object includes:
performing target object detection in the song listening mode; performing continuous mouth shape detection on the mouth of the target object when the target object is detected in the computer vision field of view, to obtain a first continuous mouth shape of the target object; and reducing the volume of the original vocal when the first continuous mouth shape matches at least part of mouth shapes of a singing object of the original vocal, which represents that the first continuous mouth shape following behavior for the target song exists at the mouth of the target object.

Specifically, the terminal may perform target object detection through the camera in the song listening mode, to detect whether the target object exists in a field of view of the camera. The field of view of the camera is a computer vision field of view. Further, the terminal may perform target object detection by performing at least one of image detection or video detection through the camera. When the target object is detected through the camera, continuous mouth shape detection is performed on the mouth of the target object, to obtain the first continuous mouth shape of the target object. The terminal may recognize the first continuous mouth shape of the target object, to determine whether the first continuous mouth shape matches at least part of the mouth shapes of the singing object of the original vocal. The singing object of the original vocal is an object that singes the song, namely, a singer of the song. The terminal reduces the volume of the original vocal when the first continuous mouth shape matches at least part of the mouth shapes of the singing object of the original vocal, which indicates that the first continuous mouth shape following behavior for the target song exists at the mouth of the target object.

In this exemplary embodiment, target object detection is performed in the song listening mode, to determine whether the target object exists. When the target object exists, continuous mouth shape detection is performed on the mouth of the target object, to determine whether the continuous mouth shape of the target object is the same as at least part of the mouth shapes of the singing object of the original vocal. If yes, the user is singing along to the song. In this case, it may be preliminarily determined that an intention of the user to sing along to the song exists. In this case, the volume of the original vocal is reduced, so that the user can hear a singing voice of the user, and this helps subsequently further confirm whether the intention of the user to sing along to the song exists.

In an exemplary embodiment, the switching, after the first continuous mouth shape following behavior, from the song listening mode to the song singing mode when the second continuous mouth shape following behavior for the target song exists at the mouth of the target object includes:
performing continuous mouth shape collection and detection on the mouth of the target object after the first continuous mouth shape following behavior, to obtain a second continuous mouth shape of the target object; and switching from the song listening mode to the song singing mode when the second continuous mouth shape matches at least part of mouth shapes of the singing object of the original vocal, which represents that the second continuous mouth shape following behavior for the target song exists at the mouth of the target object.

Specifically, after detecting that the first continuous mouth shape following behavior for the target song exists at the mouth of the target object, the terminal continues to perform image detection on the target object through the camera, and detects whether the second continuous mouth shape following behavior for the target song exists at the mouth of the target object in a plurality of successively obtained images. If yes, switching is performed from the song listening mode to the song singing mode. Otherwise, the original vocal continues to be played.

In this exemplary embodiment, the performing target object detection in the song listening mode includes: in the song listening mode, performing, by the terminal, image detection through the camera, and performing target object detection on a plurality of successively detected images.

The performing continuous mouth shape detection on the mouth of the target object when the target object is detected in the computer vision field of view, to obtain a first continuous mouth shape of the target object includes: performing continuous mouth shape detection on the mouth of the target object in the plurality of successively detected images when the target object is detected in the plurality of successively detected images, to obtain the first continuous mouth shape of the target object.

The performing continuous mouth shape detection on the mouth of the target object after the first continuous mouth shape following behavior, to obtain a second continuous mouth shape of the target object includes: after the first continuous mouth shape following behavior, continuing performing image detection, and performing continuous mouth shape detection on the mouth of the target object in the plurality of successively detected images, to obtain the second continuous mouth shape of the target object.

Specifically, in the song listening mode, the terminal may perform image obtaining through the camera, and detect whether the target object exists in the plurality of successively obtained images. When the target object exists, continuous mouth shape detection and mouth shape recognition are performed on the mouth of the target object in the plurality of successively detected images, to obtain the first continuous mouth shape of the target object, so as to detect whether the mouth of the target object in the plurality of successively obtained images matches at least part of the mouth shapes of the singing object of the original vocal. If yes, the first continuous mouth shape following behavior for the target song exists at the mouth of the target object. If yes, the volume of the original vocal is reduced. Otherwise, the original vocal continues to be played.

In this exemplary embodiment, the performing target object detection in the song listening mode includes: in the song listening mode, performing, by the terminal, video detection through the camera, and performing target object detection on a detected video.

The performing continuous mouth shape detection on the mouth of the target object when the target object is detected in the computer vision field of view, to obtain a first continuous mouth shape of the target object includes: performing continuous mouth shape detection on the mouth of the target object in the detected video when the target object is detected in the detected video, to obtain the first continuous mouth shape of the target object.

The performing continuous mouth shape detection on the mouth of the target object after the first continuous mouth shape following behavior, to obtain a second continuous mouth shape of the target object includes: continuing performing video detection after the first continuous mouth shape following behavior for the target song exists at the mouth of the target object in the computer vision field of view, and performing continuous mouth shape detection on the mouth of the target object in the detected video, to obtain the second continuous mouth shape of the target object.

In an exemplary embodiment, the performing target object detection in the song listening mode includes: performing video detection through the camera in the song listening mode.

The performing continuous mouth shape detection on the mouth of the target object when the target object is detected in the computer vision field of view, to obtain a first continuous mouth shape of the target object includes: performing continuous mouth shape detection on the mouth of the target object in the detected video when the target object is detected in the detected video, to obtain the first continuous mouth shape of the target object.

The performing continuous mouth shape detection on the mouth of the target object after the first continuous mouth shape following behavior, to obtain a second continuous mouth shape of the target object includes: continuing performing video detection after the first continuous mouth shape following behavior for the target song exists at the mouth of the target object in the recorded video, and performing continuous mouth shape detection on the mouth of the target object in the detected video, to obtain the second continuous mouth shape of the target object.

In this exemplary embodiment, whether the first continuous mouth shape of the target object is the same as at least part of the mouth shapes of the singing object of the original vocal is used to preliminarily determine whether the user is singing along to the song. In this case, the volume of the original vocal may be reduced when it is preliminarily determined that the intention of the user to sing along to the song exists, so as to further subsequently confirm whether an intention of the user to sing exists. After matching of the first continuous mouth shape, if a case in which a continuous mouth shape of the user is the same as at least part of the mouth shapes of the original vocal further exists, it may be determined again that the user needs to sing the song. In this case, switching is automatically performed from the song listening mode to the song singing mode, so that the user does not need to manually adjust the song modes, thereby achieving flexible adjustment of the song modes. In addition, whether the user is singing along to the song is determined through a plurality of times of continuous mouth shape detection, so that the determination is more accurate, thereby improving accuracy of song switching.

In an exemplary embodiment, the first continuous following behavior includes a first continuous voice following behavior, and the second continuous following behavior includes a second continuous voice following behavior. The reducing a volume of the original vocal in response to the first continuous following behavior for the target song includes:
reducing the volume of the original vocal in the song listening mode when a first following voice of the target object exists and the first following voice indicates the first continuous voice following behavior for the target song.

The switching from the song listening mode to a song singing mode in response to a second continuous following behavior after the first continuous following behavior includes:
switching from the song listening mode to the song singing mode when a second following voice of the target object after the first following voice exists and the second following voice indicates the second continuous voice following behavior for the target song.

Specifically, the first continuous following behavior includes the first continuous voice following behavior. In the song listening mode, the terminal may perform real-time audio detection, to detect whether the first continuous voice following behavior of the target object for the target song exists. When the terminal detects the first following voice of the target object, wherein the first following voice indicates the first continuous voice following behavior for the target song, the terminal may determine a current playing volume of the original vocal, reduce the current playing volume of the original vocal, and play the original vocal with the reduced volume.

When not detecting the first following voice of the target object, or detecting the first following voice of the target object, wherein the first following voice does not indicate the first continuous voice following behavior for the target song, the terminal continues to play the original vocal.

The second continuous following behavior includes the second continuous voice following behavior. The terminal continues to perform real-time audio detection on the target object after detecting that the first continuous voice following behavior of the target object for the target song exists. After the first continuous voice following behavior of the target object for the target song exists, when it is still detected that the second continuous voice following behavior of the target object for the target song exists, the target song is switched from the song listening mode to the song singing mode, and the original vocal of the target song is switched to the song accompaniment of the target song. To be specific, when detecting that the second following voice of the target object further exists after the first following voice of the target object, wherein the second following voice indicates the second continuous voice following behavior for the target song, the terminal switches the target song from the song listening mode to the song singing mode, and switches the original vocal of the target song to the song accompaniment of the target song.

When not detecting the second following voice of the target object, or detecting the second following voice of the target object, wherein the second following voice does not indicate the second continuous voice following behavior for the target song, the terminal continues to play the original vocal with the reduced volume.

In this exemplary embodiment, the first continuous following behavior includes the first continuous voice following behavior, and the second continuous following behavior includes the second continuous voice following behavior, so that volume reduction of the original vocal and flexible switching of the song mode can be automatically implemented based on a plurality of continuous voice following behaviors of the song by the user. In the song listening mode, when the first following voice of the target object exists and the first following voice indicates the first continuous voice following behavior for the target song, it represents that the user is singing along to the played target song. In this case, the volume of the original vocal is reduced, so that the user can hear a singing along voice of the user, and further confirm, based on the singing along, whether to switch to the song singing mode is required. When the second following voice of the target object after the first following voice exists and the second following voice indicates the second continuous following behavior for the target song, it represents that the user has a plurality of times of continuous singing along to the target song, which means that the user expects to singing along to the song. In this case, switching is automatically performed from the song listening mode to the song singing mode, so that the song mode can be flexibly adjusted based on the singing along of the user.

In an exemplary embodiment, interval duration between the second following voice and the first following voice is less than a second duration threshold, and interval duration between the second continuous voice following behavior and the first continuous voice following behavior is less than a second duration threshold. The switching from the song listening mode to the song singing mode when a second following voice of the target object after the first following voice exists and the second following voice indicates the second continuous voice following behavior for the target song includes:
switching from the song listening mode to the song singing mode when the second following voice of the target object after the first following voice exists, the interval duration between the second following voice and the first following voice is less than the second duration threshold, the second following voice indicates the second continuous voice following behavior for the target song, and the interval duration between the second continuous voice following behavior and the first continuous voice following behavior is less than the second duration threshold.

The second duration threshold is a critical duration value preset based on experience. The second duration threshold is used as one of conditions for whether to switch from the song listening mode to the song singing mode. The second duration threshold may be different from the first duration threshold, or may be the same as the first duration threshold.

In an exemplary embodiment, the first continuous following behavior includes a first continuous voice following behavior, and the second continuous following behavior includes a second continuous voice following behavior. The reducing a volume of the original vocal in response to the first continuous following behavior for the target song includes: recording an audio in the song listening mode; and reducing the volume of the original vocal when the first following voice of the target object exists in the recorded audio and the first following voice indicates the first continuous voice following behavior for the target song.

The switching from the song listening mode to a song singing mode in response to a second continuous following behavior after the first continuous following behavior includes: switching from the song listening mode to the song singing mode when the second following voice of the target object after the first following voice exists in the recorded audio and the second following voice indicates the second continuous voice following behavior for the target song.

In an exemplary embodiment, the reducing the volume of the original vocal in the song listening mode when a first following voice of the target object exists and the first following voice indicates the first continuous voice following behavior for the target song includes:
performing target object detection in the song listening mode; obtaining the first following voice of the target object when the target object is detected in a computer vision field of view; and reducing the volume of the original vocal when the first following voice matches at least part of continuous singing voices of the target song, which represents that the first following voice indicates the first continuous voice following behavior for the target song.

Specifically, in the song listening mode, the terminal may perform target object detection through the camera. When the target object exists in a field of view of the camera, the terminal may obtain an audio in real time, to detect the first following voice of the target object in the obtained audio. Further, the terminal may record an audio in real time, to detect the first following voice of the target object in the recorded audio.

The terminal compares the first following voice with singing voices of the target song, and reduces the volume of the original vocal when the first following voice matches at least part of continuous singing voices of the target song, which indicates that the first following voice indicates the first continuous voice following behavior for the target song.

In this exemplary embodiment, target object detection is performed in the song listening mode, to determine whether the target object exists. If the target object exists, the first following voice of the target object is detected, to determine whether the target object is singing along to the original vocal. When the first following voice is the same as at least part of the continuous singing voice of the target song, the user is singing along to the played target song. In this case, the volume of the original vocal is reduced, so that the user can hear a singing along voice of the user, and further confirm, based on the singing along, whether to switch to the song singing mode is required.

In an exemplary embodiment, the switching from the song listening mode to the song singing mode when a second following voice of the target object after the first following voice exists and the second following voice indicates the second continuous voice following behavior for the target song includes:
obtaining the second following voice of the target object after the first following voice after the first following voice indicates the first continuous voice following behavior for the target song; and switching from the song listening mode to the song singing mode when the second following voice matches at least part of continuous singing voices of the target song, which represents that the second following voice indicates the second continuous voice following behavior for the target song.

Specifically, the second following voice of the target object after the first following voice is detected in the obtained audio after the existence of the first following voice of the target object indicates the first continuous voice following behavior for the target song. The terminal compares the second following voice with singing voices of the target song, and switches from the song listening mode to the song singing mode when the second following voice matches at least part of continuous singing voices of the target song, which represents that the second following voice indicates the second continuous voice following behavior for the target song.

In this exemplary embodiment, in the song listening mode, the terminal may perform target object detection through the camera, and perform real-time audio detection on the target object through the camera when the target object exists in a field of view of the camera, to detect whether the first continuous voice following behavior of the target object for the target song exists. When the terminal can detect the first following voice of the target object through real-time audio detection, wherein the first following voice indicates the first continuous voice following behavior for the target song, the terminal may determine a current playing volume of the original vocal, reduce the current playing volume of the original vocal, and play the original vocal with the reduced volume.

When the target object does not exist in the computer vision field of view, the original vocal continues to be played. When the target object exists in the computer vision field of view and the first following voice of the target object does not exist, the original vocal continues to be played. When the target object exists in the computer vision field of view, the first following voice of the target object exists, and the first following voice does not indicate the first continuous voice following behavior for the target song, the original vocal continues to be played.

Real-time audio detection continues to be performed when the first following voice of the target object is detected, to detect whether the second continuous voice following behavior of the target object for the target song exists. Switching is performed from the song listening mode to the song singing mode when the second following voice of the target object after the first following voice exists and the second following voice indicates the second continuous following behavior for the target song.

The original vocal continues to be played when the target object exists in the computer vision field of view and the second following voice of the target object does not exist. The original vocal continues to be played when the target object exists in the computer vision field of view, the second following voice exists in the target object, and the second following voice does not indicate the second continuous voice following behavior for the target song.

In this exemplary embodiment, it is determined, based on the first following voice of the target object, whether the target object is singing along to the original vocal. If yes, the volume of the original vocal is reduced, and it is further determined, based on the singing along, whether to switch to the song singing mode is required. When the second following voice of the target object after the first following voice exists, and the second following voice is the same as at least part of a continuous singing voice of the target song, it represents that the user has a plurality of times of continuous singing along to the target song, which means that the user expects to sing the song. In this case, switching is automatically performed from the song listening mode to the song singing mode, so that the song mode can be flexibly adjusted based on the singing along of the user.

In an exemplary embodiment, the first continuous following behavior includes a first continuous mouth shape following behavior and a first continuous voice following behavior, and the second continuous following behavior includes a second continuous mouth shape following behavior and a second continuous voice following behavior. The reducing a volume of the original vocal in response to the first continuous following behavior for the target song includes:
reducing the volume of the original vocal in the song listening mode when the target object exists in the computer vision field of view, the first continuous mouth shape following behavior for the target song exists at the mouth of the target object, and the first continuous voice following behavior of the target object for the target song exists.

The switching from the song listening mode to a song singing mode in response to a second continuous following behavior after the first continuous following behavior includes:
after the first continuous mouth shape following behavior for the target song exists at the mouth of the target object in the computer vision field of view and the first continuous voice following behavior of the target object for the target song exists, when the second continuous mouth shape following behavior and the second continuous voice following behavior for the target song exist, switching from the song listening mode to the song singing mode.

In an exemplary embodiment, the reducing the volume of the original vocal in the song listening mode when the target object exists in the computer vision field of view, the first continuous mouth shape following behavior for the target song exists at the mouth of the target object, and the first continuous voice following behavior of the target object for the target song exists includes:
reducing the volume of the original vocal in the song listening mode when the target object exists in the computer vision field of view, the first continuous mouth shape following behavior for the target song exists at the mouth of the target object, the first following voice of the target object exists, and the first following voice indicates the first continuous voice following behavior for the target song.

The after the first continuous mouth shape following behavior for the target song exists at the mouth of the target object in the computer vision field of view and the first continuous voice following behavior of the target object for the target song exists, when the second continuous mouth shape following behavior and the second continuous voice following behavior for the target song exist, switching from the song listening mode to the song singing mode includes:
after the first continuous mouth shape following behavior for the target song exists at the mouth of the target object in the computer vision field of view and the first following voice indicates the first continuous voice following behavior for the target song, when the second continuous mouth shape following behavior for the target song exists, the second following voice of the target object after the first following voice exists, and the second following voice indicates the second continuous voice following behavior for the target song, switching from the song listening mode to the song singing mode.

In an exemplary embodiment, the reducing the volume of the original vocal when the first following voice matches at least part of continuous singing voices of the target song, which represents that the first following voice indicates the first continuous voice following behavior for the target song includes: performing speech recognition on the first following voice, to obtain corresponding first speech recognition text; and reducing the volume of the original vocal when a continuous tone in the first following voice matches at least part of a continuous melody of the target song and the first speech recognition text matches at least part of lyrics of the target song, which represents that the first following voice indicates the first continuous voice following behavior for the target song.

Specifically, the first continuous following behavior includes the first continuous voice following behavior. In the song listening mode, the terminal may perform voice detection, to detect whether the first continuous voice following behavior of the target object for the target song exists. The voice detection, namely, audio detection, may be real-time detection, or the detection may be performed at specific duration intervals. When detecting the first following voice of the target object, the terminal performs melody matching processing on the first following voice and the target song, to determine whether a continuous tone that matches at least part of a continuous melody of the target song exists in the first following voice, that is, determine whether there is a continuous tone, in the first following voice, that matches at least part of the continuous melody of the target song. The terminal performs speech recognition on the first following voice, to obtain the corresponding first speech recognition text. The terminal performs lyrics matching processing on the first speech recognition text and lyrics of the target song, to determine whether the first speech recognition text matches at least part of the lyrics of the target song.

When the first following voice includes the continuous tone matching at least part of the continuous melody of the target song, and the first speech recognition text of the first following voice matches at least part of the lyrics of the target song, it is determined that the first following voice indicates the first continuous voice following behavior for the target song. In this case, the terminal may determine a current playing volume of the original vocal, reduce the current playing volume of the original vocal, and play the original vocal with the reduced volume.

In this exemplary embodiment, target object detection is performed in the song listening mode, to determine whether the target object exists. If the target object exists, the first following voice of the target object is detected and converted into the first speech recognition text. When the continuous tone in the first following voice matches at least part of the continuous melody of the target song and the first speech recognition text matches at least part of the lyrics of the target song, it is determined that the first following voice indicates the first continuous voice following behavior for the target song, so that the matching of the continuous tone of the target song and the matching of the speech recognition text that are performed by the user can be used as a condition for reducing the volume of the original vocal, thereby preliminarily recognizing a singing along intention of the user.

In an exemplary embodiment, the switching from the song listening mode to the song singing mode when the second following voice matches at least part of continuous singing voices of the target song, which represents that the second following voice indicates the second continuous voice following behavior for the target song includes: performing speech recognition on the second following voice, to obtain corresponding second speech recognition text; and switching from the song listening mode to the song singing mode when a continuous tone in the second following voice matches at least part of a continuous melody of the target song and the second speech recognition text matches at least part of lyrics of the target song, which represents that the second following voice indicates the second continuous voice following behavior for the target song.

In this exemplary embodiment, when the first following voice indicates the first continuous voice following behavior for the target song, the first following voice includes a continuous tone matching at least part of a continuous melody of the target song, and speech recognition text of the first following voice matches at least part of lyrics of the target song; and when the second following voice indicates the second continuous voice following behavior for the target song, the second following voice includes a continuous tone matching at least part of a continuous melody of the target song, and speech recognition text of the second following voice matches at least part of lyrics of the target song.

Specifically, the second continuous following behavior includes the second continuous voice following behavior. The terminal continues to perform voice detection on the target object after detecting that the first following voice indicates the first continuous voice following behavior for the target song. The terminal performs melody matching processing on the second following voice and the target song when detecting the second following voice of the target object, to determine whether a continuous tone that matches at least part of a continuous melody of the target song exists in the second following voice, that is, determine whether there is a continuous tone, in the second following voice, that matches at least part of the continuous melody of the target song. The terminal performs speech recognition on the second following voice, to obtain corresponding second speech recognition text. The terminal performs lyrics matching processing on the second speech recognition text of the second following voice and lyrics of the target song, to determine whether the speech recognition text of the second following voice matches at least part of the lyrics of the target song.

When the second following voice includes the continuous tone matching at least part of the continuous melody of the target song, and the second speech recognition text of the second following voice matches at least part of the lyrics of the target song, it is determined that the second following voice indicates the second continuous voice following behavior for the target song. In this case, the target song is switched from the song listening mode to the song singing mode, and the original vocal of the target song is switched to the song accompaniment of the target song.

In this exemplary embodiment, the volume of the original vocal is reduced after it is determined that the first following voice indicates the first continuous voice following behavior for the target song. Speech recognition is performed on the second following voice based on volume reduction, to obtain the corresponding second speech recognition text. When the continuous tone in the second following voice matches at least part of the continuous melody of the target song and the second speech recognition text matches at least part of the lyrics of the target song, it is determined that the second following voice indicates the second continuous voice following behavior for the target song, so that matching of the continuous tone of the target song and matching of the speech recognition text that are performed by the user can be used as a condition for switching of a song mode, thereby accurately determining mode switching and flexibly adjusting switching from the song listening mode to the song singing mode. In addition, the determining is performed based on two conditions: continuous tone matching and lyrics matching, so that determining on a singing along behavior of the user is more accurate.

In an exemplary embodiment, the obtaining the first following voice of the target object when the target object is detected in a computer vision field of view includes: obtaining, when the target object is detected in the computer vision field of view, first audio obtained by performing audio detection on the target object, the first following voice of the target object being recorded in the first audio.

The performing speech recognition on the first following voice, to obtain corresponding first speech recognition text includes: transmitting first intermediate audio obtained by locally performing noise reduction and compression processing on the first audio to a server; and receiving the first speech recognition text corresponding to the first following voice fed back by the server based on the first intermediate audio.

The first following voice is detected and recorded into the first audio. The first audio is transmitted, after being locally noise reduced and compressed, to the server for speech recognition, to obtain the first speech recognition text that is of the first following voice and that is fed back by the server.

Specifically, in the song listening mode, the terminal may perform target object detection and audio detection, to obtain corresponding first audio. The first following voice of the target object is obtained from the first audio when the target object is detected in the field of view of the camera of the terminal. The terminal may perform noise reduction processing and compression processing on the first audio, to obtain the first intermediate audio, and transmit the first intermediate audio to the server. After receiving the first intermediate audio, the server performs decompression processing, and performs speech recognition on audio obtained through decompression processing, to obtain speech recognition text, namely, the first speech recognition text, corresponding to the first following voice of the target object. The server feeds back the first speech recognition text to the terminal.

The terminal performs melody matching processing on the first following voice and the target song, to determine whether a continuous tone that matches at least part of a continuous melody of the target song exists in the first following voice. The terminal performs lyrics matching processing on the first speech recognition text of the first following voice and the lyrics of the target song, to determine whether the first speech recognition text of the first following voice matches at least part of the lyrics of the target song. When the first following voice includes the continuous tone matching at least part of the continuous melody of the target song, and the first speech recognition text matches at least part of the lyrics of the target song, it is determined that the first following voice indicates the first continuous voice following behavior for the target song. In this case, the terminal reduces the volume of the original vocal.

In this exemplary embodiment, the first audio is detected and transmitted, after being locally noise reduced and compressed, to the server for speech recognition, to obtain the first following voice and the corresponding speech recognition text, so that it can be determined whether the first following voice includes the continuous tone matching at least part of the continuous melody of the target song, and it can be determined whether the speech recognition text of the first following voice matches at least part of the lyrics of the target song. In this way, whether matching of the tone of the first following voice is implemented and whether matching of the speech recognition text is implemented are used as a condition for reducing the volume of the original vocal, thereby accurately recognizing whether a sing along intention of the user exists.

In an exemplary embodiment, the detecting the second following voice of the target object after the first following voice after the existence of the first following voice of the target object indicates the first continuous voice following behavior for the target song includes: obtaining, after the existence of the first following voice of the target object indicates the first continuous voice following behavior for the target song, second audio obtained by performing audio detection on the target object after the first audio is detected, the second following voice of the target object being recorded in the second audio.

The performing speech recognition on the second following voice, to obtain corresponding second speech recognition text includes: transmitting second intermediate audio obtained by locally performing noise reduction and compression processing on the second audio to the server; and receiving the second speech recognition text corresponding to the second following voice fed back by the server based on the second intermediate audio.

The second following voice is detected and recorded into the second audio. The second audio is transmitted, after being locally noise reduced and compressed, to the server for speech recognition, to obtain the first speech recognition text that is of the second following voice and that is fed back by the server.

Specifically, the terminal may continue to perform audio detection after detecting that the first following voice indicates the first continuous voice following behavior for the target song, to obtain the corresponding second audio. The second following voice of the target object is obtained from the second audio. The terminal may perform noise reduction processing and compression processing on the second audio, and transmit the second intermediate audio obtained after the compression to the server. After receiving the second intermediate audio, the server performs decompression processing, and performs speech recognition on audio obtained through decompression processing, to obtain the second speech recognition text corresponding to the target object. The server feeds back the second speech recognition text to the terminal.

The terminal performs melody matching processing on the second following voice and the target song, to determine whether a continuous tone that matches at least part of a continuous melody of the target song exists in the second following voice. The terminal performs lyrics matching processing on the second speech recognition text and lyrics of the target song, to determine whether the second speech recognition text matches at least part of the lyrics of the target song. When the second following voice includes the continuous tone matching at least part of the continuous melody of the target song, and the second speech recognition text matches at least part of the lyrics of the target song, it is determined that the second following voice indicates the second continuous voice following behavior for the target song, and switching is performed from the song listening mode to the song singing mode.

In an exemplary embodiment, the terminal may obtain the first following voice of the target object from the first audio, and transmit the first following voice after being locally noise reduced and compressed to the server for speech recognition, to obtain speech recognition text that corresponds to the first following voice and that is fed back by the server.

The terminal may obtain the second following voice of the target object from the second audio, and transmit the second following voice after being locally noise reduced and compressed to the server for speech recognition, to obtain speech recognition text that corresponds to the second following voice and that is fed back by the server.

In this exemplary embodiment, whether matching of the tone of the first following voice is implemented and whether matching of the speech recognition text is implemented are used as a condition for reducing the volume of the original vocal, to accurately recognize whether a singing intention of the user exists. After the volume is reduced, the second audio is detected and transmitted, after being locally noise reduced and compressed, to the server for speech recognition, to obtain the second following voice and the corresponding speech recognition text, so that it can be determined whether the second following voice includes the continuous tone matching at least part of the continuous melody of the target song, and it can be determined whether the speech recognition text of the second following voice matches at least part of the lyrics of the target song. In this way, whether matching of the tone of the second following voice is implemented and whether matching of the speech recognition text is implemented are used as a condition for mode switching, specifically as a condition for switching from the song listening mode to the song singing mode, so that it can be accurately determined whether mode switching needs to be performed, thereby accurately switching the song mode.

In an exemplary embodiment, duration of the first following voice meets a first duration condition for the first continuous voice following behavior, and duration of the second following voice meets a second duration condition for the second continuous voice following behavior.

The first duration condition is a preset duration condition for reducing the volume of the original vocal. The second duration condition is a preset duration condition for switching from the song listening mode to the song singing mode. For example, the first duration condition refers to “greater than 6 or 12 seconds”, and the second duration condition refers to “greater than 18 seconds”, but is not limited thereto.

Specifically, in the song listening mode, the terminal may perform real-time audio detection, to detect whether the first continuous voice following behavior of the target object for the target song exists. When detecting the first following voice of the target object, wherein the first following voice indicates the first continuous voice following behavior for the target song, the terminal determines the duration of the first following voice, and determines whether the duration of the first following voice meets the first duration condition. When the duration of the first following voice meets the first duration condition for the first continuous voice following behavior, the terminal may determine a current playing volume of the original vocal, reduce the current playing volume of the original vocal, and play the original vocal with the reduced volume.

The terminal continues to perform real-time audio detection on the target object after detecting that the first continuous voice following behavior of the target object for the target song exists. When detecting that the second following voice of the target object for the target song further exists after the first following voice of the target object, wherein the second following voice indicates the second continuous voice following behavior for the target song, the terminal determines the duration of the second following voice, and determines whether the duration of the second following voice meets the second duration condition. When the duration of the second following voice meets the second duration condition for the second continuous voice following behavior, the target song is switched from the song listening mode to the song singing mode, and the original vocal of the target song is switched to the song accompaniment of the target song.

In this exemplary embodiment, when the duration of the first following voice meets the first duration condition for the first continuous voice following behavior, the singing along duration of the user for the target song meets a preset condition for reducing the volume. In this case, it means that an intention of the user to sing exists. In this case, the volume of the original vocal may be automatically reduced based on the singing along duration of the user, so that the user can hear a singing along voice of the user. When the duration of the second following voice meets the second duration condition for the second continuous voice following behavior, the singing along duration of the user for the target song already meets a preset condition for mode switching. In this case, switching may be automatically performed from the song listening mode to the song singing mode based on the singing along duration of the user, to flexibly implement real-time switching of song modes.

In an exemplary embodiment, the first continuous following behavior includes at least two following sub-behaviors performed in sequence. The reducing a volume of the original vocal in response to the first continuous following behavior for the target song includes:

reducing, in response to each of the following sub-behaviors in the first continuous following behavior for the target song, each current volume of the original vocal until the volume of the original vocal reaches a minimum volume in response to the first continuous following behavior after a last following sub-behavior.

Specifically, the first continuous following behavior includes at least two following sub-behaviors performed in sequence. The terminal may perform real-time detection on the target object, to recognize whether the continuous following behavior of the target object for the target song exists. When detecting for the first time that the following sub-behavior of the target object for the target song exists, the terminal determines a current volume of the original vocal, and reduces the current volume of the original vocal. Real-time detection continues to be performed. When detecting again that the following sub-behavior of the target object for the target song exists, the terminal determines a current volume of the original vocal, reduces the current volume of the original vocal again, and continues to perform real-time detection. For each of the following sub-behaviors of the target object for the target song, an operation of reducing the current volume of the original vocal is correspondingly performed until the volume of the original vocal after the last following sub-behavior reaches the minimum volume in response to the first continuous following behavior. The minimum volume in response to the first continuous following behavior may be preset, for example, set to 20. After the operation of reducing the current volume of the original vocal is performed, the current volume of the original vocal reaches the minimum volume. In this case, the response to the first continuous following behavior ends.

In an exemplary embodiment, the first continuous following behavior includes a first continuous mouth shape following behavior. In this case, the first continuous following behavior includes at least two mouth shape following sub-behaviors performed in sequence. For example, if the first continuous following behavior includes the two mouth shape following sub-behaviors performed in sequence, the terminal reduces a current volume of the original vocal in response to a first mouth shape following sub-behavior for the target song; and continues to reduce the current volume of the original vocal in response to a second mouth shape following sub-behavior for the target song, wherein a volume of the original vocal after the second mouth shape following sub-behavior reaches a minimum volume in response to a first continuous mouth shape following behavior.

In an exemplary embodiment, the first continuous following behavior includes a first continuous voice following behavior. In this case, the first continuous following behavior includes at least two voice following sub-behaviors performed in sequence.

In this exemplary embodiment, the first continuous following behavior includes at least two following sub-behaviors. Each time a following sub-behavior of the user for the song is detected, a current playing volume of the original vocal is reduced, so that the volume of the original vocal is automatically reduced at least twice until the volume of the original vocal reaches the minimum volume in response to the first continuous following behavior after a last following sub-behavior. A plurality of automatic volume reduction conditions are set, so that the volume reduction conditions are more refined and meet user needs more.

In an exemplary embodiment, the method further includes: displaying a mode-switching interaction element; switching, in response to a triggering operation on the mode-switching interaction element in the song listening mode, from the song listening mode to the song singing mode; and playing, in the song singing mode, a song accompaniment of the target song from song progress that is of the target song and that is indicated by the original vocal.

The interaction element is a visual element that can be operated by a user. The visible element is an element that can be displayed and that is visible to human eyes, and is used to transfer information. The mode-switching interaction element is a visual element configured for switching a song mode. The mode-switching interaction element has a variety of expression forms, and may be, for example, a control, a button, a space-filled box, a radio box, an option group, an image, text, a logo, a link, or the like, but is not limited thereto.

The trigger operation may be any operation of triggering the mode-switching interaction element, and may be specifically a touch operation, a cursor operation, a key operation, a voice operation, an action operation, or the like, but is not limited thereto. The touch operation may be a touch/tap operation, a touch/press operation, or a touch/swipe operation, and the touch operation may be a single touch operation or a multi-touch operation. The cursor operation may be an operation of controlling a cursor to perform clicking or an operation of controlling the cursor to perform pressing. The key operation may be a virtual key operation, an entity key operation, or the like. The speech operation may be an operation controlled through speech. The action operation may be an operation controlled by a user action, for example, a hand action or a head action of the user.

Specifically, the terminal plays an original vocal of the target song in the song listening mode, and displays the mode-switching interaction element. The user may trigger the mode-switching interaction element to trigger a song mode switching event. When detecting a triggering operation on the mode-switching interaction element by the user, the terminal determines, in response to the triggering operation on the mode-switching interaction element, whether a current song mode is the song listening mode or the song singing mode. When the current song mode is the song listening mode, the terminal switches the current song mode from the song listening mode to the song singing mode, determines current song progress that is of the target song and that is indicated by the original vocal, and determines corresponding progress of the song progress in the song accompaniment. The terminal plays, in the song singing mode, the song accompaniment from the corresponding progress of the song accompaniment.

In this exemplary embodiment, the mode-switching interaction element is displayed regardless of playing the original vocal or the song accompaniment of the target song, so as to provide an option to manually switch the song mode. In the song listening mode, the user may choose to manually trigger the mode-switching interaction element, to perform manual switching from the song listening mode to the song singing mode, thereby providing options for manual switching and automatic song mode switching. More comprehensive functions are implemented. In the song singing mode, the song accompaniment of the target song is played from the song progress that is of the target song and that is indicated by the original vocal, so that the current progress of the original vocal can be naturally transitioned to the corresponding progress of the song accompaniment, thereby achieving smooth switching of the song mode.

In an exemplary embodiment, the method further includes:
displaying a mode-switching interaction element; switching, in response to a triggering operation on the mode-switching interaction element in the song singing mode, from the song singing mode to the song listening mode; and playing, in the song listening mode, the original vocal of the target song from the song progress that is of the target song and that is indicated by the song accompaniment.

Specifically, the terminal plays the song accompaniment of the target song in the song singing mode, and displays the mode-switching interaction element. The user may trigger the mode-switching interaction element to trigger a song mode switching event. When detecting a triggering operation on the mode-switching interaction element by the user, the terminal determines, in response to the triggering operation on the mode-switching interaction element, whether a current song mode is the song listening mode or the song singing mode. When the current song mode is the song singing mode, the terminal switches the current song mode from the song singing mode to the song listening mode, determines current song progress that is of the target song and that is indicated by the song accompaniment, and determines corresponding progress of the song progress in the original vocal. In the song listening mode, the terminal plays the original vocal from the corresponding progress of the original vocal.

In this exemplary embodiment, the mode-switching interaction element is displayed regardless of playing the original vocal or the song accompaniment of the target song, to provide an option to manually switch the song mode. In the song singing mode, the user may choose to manually trigger the mode-switching interaction element, to perform manual switching from the song singing mode to the song listening mode, thereby providing options for manual switching and automatic song mode switching. Selection manners are more diverse. In the song listening mode, the original vocal of the target song is played from the song progress that is of the target song and that is indicated by the song accompaniment, so that the current progress of the song accompaniment can be naturally transitioned to the corresponding progress of the original vocal, and the original vocal does not need to be played from the beginning, thereby effectively achieving smooth switching of the song mode.

In an exemplary embodiment, the method further includes:
switching, in the song singing mode, from the song singing mode to the song listening mode when silence duration of the target object meets a duration condition for indicating to abandon following the target song; and playing, in the song listening mode, the original vocal of the target song from the song progress that is of the target song and that is indicated by the song accompaniment.

The duration condition for indicating to abandon following the target song is a duration condition for abandoning the song listening mode.

Specifically, in the song singing mode, the terminal may detect a voice of the target object in real time or at specific duration intervals. When the voice of the target object is not detected, the target object is in a silent state. In this case, the terminal may record duration, that is, silence duration, during which the target object is in the silent state. The terminal matches the silence duration of the target object with the duration condition for indicating to abandon following the target song, to determine whether the silence duration of the target object meets the duration condition. If yes, the user does not expect to continue singing. In this case, the terminal switches the target song from the song singing mode to the song listening mode, thereby switching the song accompaniment to the original vocal.

The terminal switches from the song singing mode to the song listening mode, determines current song playing progress that is of the target song and that is indicated by the song accompaniment, and determines corresponding progress of the song progress in the original vocal. In the song listening mode, the terminal starts to play the original vocal from the corresponding progress of the original vocal.

For example, in the song singing mode, it is detected that the user is in the silent state for at least six seconds. In this case, switching back to the song listening mode is automatically performed, to play the original vocal.

In an exemplary embodiment, in the song listening mode, the original vocal of the target song is played at a preset volume from the song progress that is of the target song and that is indicated by the song accompaniment.

In an exemplary embodiment, the switching, in the song singing mode, from the song singing mode to the song listening mode when silence duration of the target object meets a duration condition for indicating to abandon following the target song includes: recording an audio in the song singing mode; and switching from the song singing mode to the song listening mode when the silence duration of the target object in the recorded audio meets the duration condition for indicating to abandon following the target song.

In this exemplary embodiment, in the song singing mode, when the silence duration of the target object meets the duration condition for indicating to abandon following the target song, the user does not have an intention to continue singing, to be specific, the user does not expect to continue singing the song. In this case, the target song is automatically and accurately switched from the song singing mode to the song listening mode, so that the song mode can be flexibly adjusted and smoothly switched. In the song listening mode, the original vocal of the target song is played from the song progress that is of the target song and that is indicated by the song accompaniment, so that the current progress of the song accompaniment can be naturally transitioned to the corresponding progress of the original vocal, and the original vocal does not need to be played from the beginning, thereby effectively achieving smooth transition between the song accompaniment and the original vocal.

In an exemplary embodiment, in the song singing mode, when the silence duration of the target object meets the duration condition for indicating to abandon following the target song, prompt information indicating to switch to the song listening mode is displayed. Switching is performed from the song singing mode to the song listening mode in response to a confirmation operation on the prompt information indicating to switch to the song listening mode. The song accompaniment continues to be played in response to a rejection operation on the prompt information indicating to switch to the song listening mode.

In an exemplary embodiment, the method further includes:
switching, in the song singing mode, from the song singing mode to the song listening mode when duration of a song singing voice of the target object mects a preset duration condition and speech recognition text of the song singing voice does not match lyrics of the target song.

The preset duration condition is a duration condition for satisfaction of using the song listening mode. For example, the preset duration condition may be six seconds or eight seconds, but is not limited thereto.

Specifically, in the song singing mode, the terminal may detect a song singing voice of the target object in real time or at specific duration intervals, and perform speech recognition on the song singing voice of the target object, to obtain corresponding speech recognition text. The terminal compares the duration of the song singing voice of the target object with the preset duration condition, and compares the speech recognition text with the lyrics of the target song. When the duration of the song singing voice of the target object meets the preset duration condition, and the speech recognition text of the song singing voice matches the lyrics of the target song, the song accompaniment continues to be played in the song singing mode, and next voice detection and comparison are performed. That the speech recognition text matches the lyrics of the target song may be specifically that there are a preset quantity of identical lyrics in the speech recognition text and the lyrics of the target song. The preset quantity may be a quantity of words in the lyrics or a quantity of sentences in the lyrics. For example, there are at least 20 identical words in the lyrics or at least three identical sentences in the lyrics.

When the duration of the song singing voice of the target object meets the preset duration condition, and the speech recognition text of the song singing voice does not match the lyrics of the target song, switching is performed from the song singing mode to the song listening mode, and in the song listening mode, the original vocal of the target song is played from the song progress that is of the target song and that is indicated by the song accompaniment. That the speech recognition text does not match the lyrics of the target song may be specifically that there are a preset quantity of non-identical lyrics in the speech recognition text and the lyrics of the target song. The preset quantity may be a quantity of words of the lyrics or a quantity of sentences of the lyrics. For example, there are at least 20 non-identical words in the lyrics or at least three non-identical sentences in the lyrics.

In an exemplary embodiment, in the song singing mode, the terminal may detect a song singing voice of the target object in real time or at specific duration intervals. When the duration of the song singing voice of the target object meets the preset duration condition, speech recognition is performed on the song singing voice of the target object, to obtain corresponding speech recognition text. The terminal compares the speech recognition text with the lyrics of the target song. When the speech recognition text matches the lyrics of the target song, the song accompaniment continues to be played in the song singing mode, and next voice detection and comparison are performed.

When the speech recognition text does not match the lyrics of the target song, switching is performed from the song singing mode to the song listening mode, and the original vocal of the target song is played in the song listening mode from the song progress that is of the target song and that is indicated by the song accompaniment.

In this exemplary embodiment, in the song singing mode, when the duration of the song singing voice of the target object meets the preset duration condition, and the speech recognition text of the song singing voice does not match the lyrics of the target song, it means that the user does not expect to sing the currently played song or is unfamiliar with the currently played song. In this case, switching is performed from the song singing mode to the song listening mode. In this way, the duration of the song singing voice of the user and the speech recognition text of the song singing voice can be used as two determining conditions for switching from the song singing mode to the song listening mode, thereby further improving determining accuracy of song mode switching.

In an exemplary embodiment, in the song singing mode, when the duration of the song singing voice of the target object meets the preset duration condition, and the speech recognition text of the song singing voice does not match the lyrics of the target song, prompt information indicating to switch to the song listening mode is displayed. Switching is performed from the song singing mode to the song listening mode in response to a confirmation operation on the prompt information indicating to switch to the song listening mode.

In an exemplary embodiment, in the song singing mode, when the duration of the song singing voice of the target object meets the preset duration condition, and the speech recognition text of the song singing voice does not match the lyrics of the target song, a song corresponding to the speech recognition text is detected, and prompt information indicating to play the song corresponding to the speech recognition text is displayed.

In an exemplary embodiment, the switching from the song listening mode to a song singing mode in response to a second continuous following behavior after the first continuous following behavior includes:
switching from the song listening mode to the song singing mode in response to the second continuous following behavior after the first continuous following behavior when the song accompaniment exists for the target song.

In an exemplary embodiment, the method further includes:
displaying, in response to the second continuous following behavior after the first continuous following behavior when no song accompaniment exists for the target song, prompt information indicating that no song accompaniment exists, and continuing to play the original vocal of the target song.

Specifically, the terminal continues to perform real-time detection after the first continuous following behavior. When detecting the second continuous following behavior of the user for the target song, the terminal determines whether the target song has a corresponding song accompaniment. When the song accompaniment exists for the target song, the terminal switches, in response to the second continuous following behavior for the target song, the target song from the song listening mode to the song singing mode, to switch the original vocal of the target song to the song accompaniment of the target song.

The terminal continues to perform real-time detection after the first continuous following behavior. When detecting the second continuous following behavior of the user for the target song, the terminal determines whether the target song has a corresponding song accompaniment. When no song accompaniment exists for the target song, the terminal displays, in response to the second continuous following behavior for the target song, prompt information indicating that no song accompaniment exists, and continues to play the original vocal of the target song.

In an exemplary embodiment, when detecting the second continuous following behavior of the user for the target song, the terminal interrupts playing of the original vocal, and determines whether the target song has a corresponding song accompaniment.

In another exemplary embodiment, when detecting the second continuous following behavior of the user for the target song, the terminal does not interrupt playing of the original vocal, and determines, while the original vocal is being played, whether the target song has a corresponding song accompaniment.

In this exemplary embodiment, whether the song accompaniment exists for the target song is determined in response to the second continuous following behavior after the first continuous following behavior, and if yes, switching is automatically performed from the song listening mode to the song singing mode, thereby achieving flexible adjustment of the song mode. When no song accompaniment exists for the target song, prompt information indicating that no song accompaniment exists is automatically displayed, to provide a prompt to the user that no accompaniment exists for the currently played song, and the original vocal of the target song continues to be played, so that there is no need to interrupt playing of the song in the prompt process, thereby providing a better music service.

In an exemplary embodiment, the switching from the song listening mode to a song singing mode in response to a second continuous following behavior after the first continuous following behavior includes: switching from the song listening mode to the song singing mode in response to the second continuous following behavior after the first continuous following behavior when the song accompaniment exists for the target song.

In an exemplary embodiment, the method further includes: displaying, in response to the second continuous following behavior after the first continuous following behavior when no song accompaniment exists for the target song, prompt information indicating that no song accompaniment exists, and continuing to play the original vocal of the target song.

FIG. 5 is a schematic flowchart of displaying prompt information indicating that no song accompaniment exists according to an exemplary embodiment. When detecting the second continuous following behavior after the first continuous following behavior, when no song accompaniment exists for the target song, the terminal displays, in a current interface, the prompt information indicating that no song accompaniment exists, and continues to play the original vocal of the target song, so that there is no need to jump to another interface or another application, and there is no need to interrupt current playing. Alternatively, when a specific song has no accompaniment resource, when the user selects the song singing mode, prompt information indicating that no song accompaniment exists is directly provided in the current interface, and there is no need to jump to another page or application, and there is no need to interrupt current playing.

In an exemplary embodiment, the method further includes:
displaying, in the song listening mode, original vocal weakening prompt information for the target song when a quantity of playing times of the target song meets a familiar song determining condition of the target object for the target song, the original vocal weakening prompt information being configured for indicating to trigger original vocal weakening processing for the target song, and the original vocal weakening processing including at least one of reducing the volume of the original vocal or switching to the song singing mode.

The familiar song determining condition is a preset condition for determining that the target song is a familiar song of the target object, and may specifically include a preset quantity of playing times, include preset playing duration of each time of playing, or include a quantity of playing times that satisfies the preset playing duration, or the like, but is not limited thereto. The preset quantity of playing times is, for example, five times or six times, which may be set based on a requirement.

Specifically, in the song listening mode, the terminal plays the original vocal of the target song, and detects the quantity of playing times of the target song. The terminal obtains a familiar song determining condition of the target song, matches a quantity of playing times of the target song with the familiar song determining condition, and displays original vocal weakening prompt information for the target song when the quantity of playing times meets the familiar song determining condition.

For example, the terminal compares a quantity of playing times of the target song in the song listening mode with the preset quantity of playing times, and displays the original vocal weakening prompt information for the target song when the quantity of playing times is equal to or greater than the preset quantity of playing times.

The original vocal weakening prompt information may include at least one of prompt information indicating to reduce the volume of the original vocal or prompt information indicating to switch to the song singing mode. The target object may select displayed original weakening prompt information. In response to a selection operation on the original weakening prompt information, the terminal performs original vocal weakening processing corresponding to the selection operation. For example, the terminal displays at least one of the prompt information indicating to reduce the volume of the original vocal or the prompt information indicating to switch to the song singing mode. When the target object selects the prompt information indicating to reduce the volume of the original vocal, the terminal reduces the volume of the original vocal of the target song in response to a selection operation on the prompt information indicating to reduce the volume of the original vocal. When the target object selects the prompt information indicating to switch to the song singing mode, the terminal switches from the song listening mode to the song singing mode in response to a selection operation on the prompt information indicating to switch to the song singing mode.

In an exemplary embodiment, the familiar song determining condition may include that the quantity of playing times meets the preset quantity of playing times and each playing duration meets the preset playing duration. In the song listening mode, when the quantity of playing times of the target song meets the preset quantity of playing times in the familiar song determining condition of the target object for the target song, and each playing duration meets the preset playing duration in the familiar song determining condition, the original vocal weakening prompt information for the target song is displayed.

In this exemplary embodiment, in the song listening mode, when the quantity of playing times of the target song meets the familiar song determining condition of the target object for the target song, the user is relatively familiar with the currently played song. In this case, the original vocal weakening prompt information for the target song is automatically displayed, to provide a prompt to the user whether to reduce the volume of the original vocal or to switch to the song singing mode is required. In this way, a proper intelligent prompt can be provided based on songs frequently listened to by the user, so that song playing is more flexible.

In an exemplary embodiment, the method further includes: playing the original vocal of the target song in the song listening mode; and displaying the original vocal weakening prompt information for the target song when a quantity of playing times of the original vocal of the target song meets the familiar song determining condition of the target object for the target song, the original vocal weakening prompt information being configured for indicating to trigger original vocal weakening processing for the target song, and the original vocal weakening processing including at least one of reducing the volume of the original vocal or switching to the song singing mode.

In an exemplary embodiment, the method further includes:
highlighting a currently sung lyrics sentence in the original vocal of the target song in the song listening mode; and highlighting a currently sung lyrics word in the song accompaniment of the target song after switching from the song listening mode to the song singing mode.

The lyrics sentence is a sentence of the lyrics, to be specific, a single sentence of the lyrics. The lyrics word is a single word in a single sentence of the lyrics.

Specifically, the terminal plays the original vocal of the target song in the song listening mode, and displays at least one sentence of the lyrics of the target song. In the song listening mode, when the target object sings a specific sentence of the lyrics, the terminal may highlight a currently sung lyrics sentence, so that a display manner of the currently sung lyrics sentence is different from those of other displayed lyrics sentences.

In the song singing mode, the terminal plays the song accompaniment of the target song from song progress that is of the target song and that is indicated by the original vocal, determines lyrics progress corresponding to the song progress of the target song, and starts to display at least one sentence of the lyrics of the target song from the lyrics progress. In the song singing mode, when the target object sings a specific word in a specific sentence of the lyrics, the terminal may highlight a currently sung lyrics word, so that a display manner of the currently sung lyrics word is different from those of other lyrics words in the lyrics sentence.

The highlighting may be specifically at least one of highlighting, displaying in a bold manner, zooming in, or displaying in different colors.

In an exemplary embodiment, a manner of highlighting the lyrics sentence in the song listening mode is the same as a manner of highlighting the lyrics word in the song singing mode. For example, the currently sung lyrics sentence is highlighted in the song listening mode, and the currently sung lyrics word is highlighted in the song singing mode.

In another exemplary embodiment, a manner of highlighting the lyrics sentence in the song listening mode is different from a manner of highlighting the lyrics word in the song singing mode. For example, the current sung lyrics sentence is highlighted in the song listening mode, and the current sung lyrics word is bold in the song singing mode.

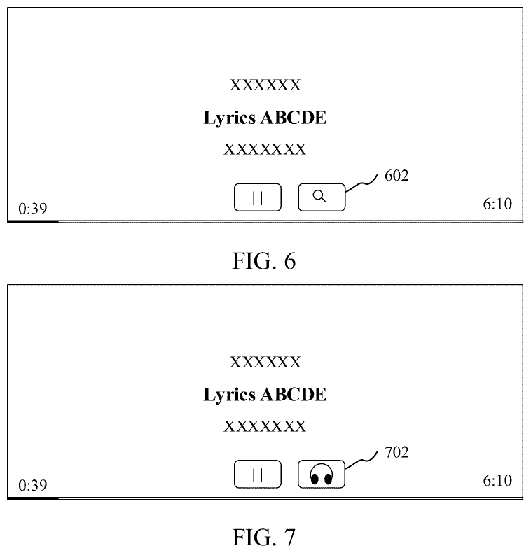

FIG. 6 is a schematic diagram of a lyrics display interface in a song listening mode according to an exemplary embodiment. At least one sentence of lyrics is displayed in the lyrics display interface in the song listening mode. When an original vocal is played to “lyrics ABCDE”, “lyrics ABCDE” is highlighted as shown in FIG. 6.

In another exemplary embodiment, a mode-switching interaction element 602 may further be displayed in the lyrics display interface. The mode-switching interaction element 602 in the song listening mode is configured for switching from the song listening mode to a song singing mode. Current playing progress may further be displayed in the lyrics display interface. For example, the current playing progress is 0:39.

FIG. 7 is a schematic diagram of a lyrics display interface in a song singing mode according to an exemplary embodiment. In the song singing mode, when a target object currently sings a “word” in “lyrics ABCDE”, the “word” is highlighted, and the remaining words are not highlighted.

In another exemplary embodiment, a mode-switching interaction element 702 may further be displayed in the lyrics display interface. The mode-switching interaction element 702 in the song singing mode is configured for switching from the song singing mode to the song listening mode. Current playing progress may further be displayed in the lyrics display interface.

In an exemplary embodiment, a display form of the mode-switching interaction element in the song listening mode is different from a display form of the mode-switching interaction element in the song singing mode. The mode-switching interaction element 602 shown in FIG. 6 is displayed as a song listening button, and the mode-switching interaction element 702 shown in FIG. 7 is displayed as a song singing button.

In the song listening mode, switching is performed from the song listening mode to the song singing mode in response to a triggering operation on the mode-switching interaction element 602, so that the mode-switching interaction element 702 shown in FIG. 7 is displayed in the song singing mode.

In the song singing mode, switching is performed from the song singing mode to the song listening mode in response to a triggering operation on the mode-switching interaction element 702, so that the mode-switching interaction element 602 shown in FIG. 6 is displayed in the song listening mode.

In this exemplary embodiment, the lyrics are highlighted sentence by sentence and the lyrics are highlighted word by word, so that lyrics display manners in the song singing mode and the song listening mode can be effectively distinguished. In addition, in the song listening mode, a currently sung lyrics sentence in the original vocal of the target song is highlighted. In this way, a sung sentence of the lyrics can be highlighted when the user is in a song listening state, so that the user focuses on the currently sung lyrics sentence, and understands a meaning of the currently sung lyrics, thereby providing better music experience to the user. After switching is performed from the song listening mode to the song singing mode, a currently sung lyrics word in the song accompaniment of the target song is highlighted, so that the user can see the currently sung word, thereby avoiding poor music experience caused by user singing off beats, missing beats, forgetting words, or the like, and helping improve accuracy of singing of the user.

In an exemplary embodiment, the method further includes:
switching, when the song accompaniment of the target song is played, from the song singing mode to the song listening mode in response to a trigger event for switching from the target song to another song; and playing an original vocal of the another song in the song listening mode.

The trigger event is an event for triggering song switching, and may be triggered by a trigger operation. The trigger operation may be specifically a touch operation, a cursor operation, a key operation, a voice operation, an action operation, or the like, but is not limited thereto. The touch operation may be a touch/tap operation, a touch/press operation, or a touch/swipe operation, and the touch operation may be a single touch operation or a multi-touch operation. The cursor operation may be an operation of controlling a cursor to perform clicking or an operation of controlling the cursor to perform pressing. The key operation may be a virtual key operation, an entity key operation, or the like. The speech operation may be an operation controlled through speech. The action operation may be an operation controlled by a user action, for example, a hand action or a head action of the user.

Specifically, the terminal plays the song accompaniment of the target song in the song singing mode. The target object may trigger an event for switching from the target song to the another song. The terminal switches from the song singing mode to the song listening mode in response to the trigger event for switching from the target song to the another song. The terminal plays an original vocal of the another song in the song listening mode.

In this exemplary embodiment, when the song accompaniment of the target song is played, the song accompaniment of the another song is played in response to the trigger event for switching from the target song to the another song.

In this exemplary embodiment, the terminal plays the song accompaniment of the target song in the song singing mode, and displays a song-switching interaction element. The target object may trigger the song-switching interaction element to switch the song, and the terminal switches, in response to a trigger event for the song-switching interaction element, from the song singing mode to the song listening mode.

In an exemplary embodiment, when the song accompaniment of the target song is played, prompt information indicating to switch to the song listening mode is displayed in response to the trigger event for switching from the target song to the another song. Switching is performed from the song singing mode to the song listening mode in response to a confirmation operation on the prompt information indicating to switch to the song listening mode. The original vocal of the another song is played in the song listening mode. The song accompaniment of the another song is played in the song singing mode in response to a rejection operation on the prompt information indicating to switch to the song listening mode.

In this exemplary embodiment, when the song accompaniment of the target song is played, switching is performed from the song singing mode to the song listening mode in response to the trigger event for switching from the target song to the another song, so that during playing of a current song, a song to be played can be switched at any time, and a song mode is automatically switched based on song switching, so that the song mode can be flexibly switched. The original vocal of the another song is played in the song listening mode, effectively satisfying song listening needs of different users.

In an exemplary embodiment, the song playing method is performed by an in-vehicle terminal, and the method further includes:
connecting the in-vehicle terminal and an in-vehicle head-up display device in response to a lyrics projection event of the target song; and projecting the lyrics of the target song from the in-vehicle terminal to the in-vehicle head-up display device for display.

The lyrics projection event is an event of projecting the lyrics, and the lyrics projection event may be triggered through a projection operation. The projection operation may be various trigger operations. The trigger operation may be specifically a touch operation, a cursor operation, a key operation, a voice operation, an action operation, or the like, but is not limited thereto. The touch operation may be a touch/tap operation, a touch/press operation, or a touch/swipe operation, and the touch operation may be a single touch operation or a multi-touch operation. The cursor operation may be an operation of controlling a cursor to perform clicking or an operation of controlling the cursor to perform pressing. The key operation may be a virtual key operation, an entity key operation, or the like. The speech operation may be an operation controlled through speech. The action operation may be an operation controlled by a user action, for example, a hand action or a head action of the user.

The in-vehicle head-up display (Head-up Display, HUD for short) device is a head-up display device used in a vehicle. The in-vehicle head-up display device may use a principle of optical reflection to project vehicle information such as a current speed per hour and navigation of the vehicle onto a front windscreen to form an image, so that a driver can view the navigation and vehicle speed information without turning or lowering the head of the driver.

Specifically, the in-vehicle terminal plays the original vocal of the target song in the song listening mode, and the in-vehicle terminal reduces the volume of the original vocal in response to the first continuous following behavior for the target song. The in-vehicle terminal switches from the song listening mode to the song singing mode in response to the second continuous following behavior after the first continuous following behavior. In the song singing mode, the in-vehicle terminal plays the song accompaniment of the target song from song progress that is of the target song and that is indicated by the original vocal.

During playing of the original vocal or during playing of the song accompaniment, the target object may project the lyrics of the target song from the in-vehicle terminal to the in-vehicle head-up display device. In response to the lyrics projection event of the target object for the target song, the in-vehicle terminal detects whether the in-vehicle terminal and the in-vehicle head-up display device are connected. When connection is not implemented, the in-vehicle terminal establishes a connection to the in-vehicle head-up display device, transmits the lyrics of the target song to the in-vehicle head-up display device, and displays the lyrics of the target song on the in-vehicle head-up display device.

In this exemplary embodiment, the song playing method is performed by the in-vehicle terminal, and the song can be automatically and accurately adjusted from the song listening mode to the song singing mode based on a plurality of times of following behaviors of the user, so that smooth switching between the song listening mode and the song singing mode can be implemented in an in-vehicle scenario, without a manual operation of the user, thereby avoiding a driving safety risk caused by an active operation of the user. In addition, in the song singing mode, the song accompaniment of the target song is played from the song progress that is of the target song and that is indicated by the original vocal, so that current progress of the original vocal can be naturally transited to corresponding progress of the song accompaniment. In this way, a song mode can be switched at any playing progress at any time, making switching of the song mode and the song playing in the in-vehicle scenario more flexible. In response to the lyrics projection event of the target song, the in-vehicle terminal and the in-vehicle head-up display device are connected. The in-vehicle head-up display device may project information such as a current speed per hour and navigation onto a windscreen to form an image, and the lyrics of the target song are displayed through the in-vehicle head-up display device, so that a driver can view lyrics information without turning or lowering the head of the driver, a driving safety risk caused by an active operation of the user is avoided, and the user is fully enjoyable to song consumption in a driving environment.

In an exemplary embodiment, a song playing method is provided and is applied to an in-vehicle terminal, and includes:
playing an original vocal of a target song in a song listening mode, and displaying a mode-switching interaction element;
next, highlighting a currently sung lyrics sentence in the original vocal of the target song in the song listening mode;
next, reducing a volume of the original vocal in the song listening mode when a target object exists in a computer vision field of view and a first continuous mouth shape following behavior for the target song exists at a mouth of the target object; and when a second continuous mouth shape following behavior for the target song exists after the first continuous mouth shape following behavior for the target song exists at the mouth of the target object in the computer vision field of view, switching from the song listening mode to the song singing mode when a song accompaniment exists for the target song.

The first continuous following behavior is a continuous following behavior with playing progress of the target song, and a second continuous following behavior is different from the first continuous following behavior, and is a continuous following behavior that is made with the playing progress of the target song and that is generated after the first continuous following behavior.

In an exemplary embodiment, after the first continuous mouth shape following behavior for the target song exists at the mouth of the target object in the computer vision field of view, when no song accompaniment exists for the target song, prompt information indicating that no song accompaniment exists is displayed, and the original vocal of the target song continues to be played.

Alternatively, the volume of the original vocal is reduced in the song listening mode when a first following voice of the target object exists and the first following voice indicates the first continuous voice following behavior for the target song. Switching is performed from the song listening mode to the song singing mode when the song accompaniment exists for the target song when a second following voice of the target object after the first following voice exists and the second following voice indicates the second continuous voice following behavior for the target song.

When the first following voice indicates the first continuous voice following behavior for the target song, the first following voice includes a continuous tone matching at least part of a continuous melody of the target song, and speech recognition text of the first following voice matches at least part of lyrics of the target song. When the second following voice indicates the second continuous voice following behavior for the target song, the second following voice includes a continuous tone matching at least part of a continuous melody of the target song, and speech recognition text of the second following voice matches at least part of lyrics of the target song. Duration of the first following voice meets a first duration condition for the first continuous voice following behavior, and duration of the second following voice meets a second duration condition for the second continuous voice following behavior.

In an exemplary embodiment, when the second following voice of the target object after the first following voice exists and the second following voice indicates the second continuous following behavior for the target song, when no song accompaniment exists for the target song, prompt information indicating that no song accompaniment exists is displayed, and the original vocal of the target song continues to be played.

In an exemplary embodiment, in the song listening mode, switching is performed from the song listening mode to the song singing mode in response to a triggering operation on the mode-switching interaction element when the song accompaniment exists for the target song.

In an exemplary embodiment, in the song listening mode, in response to a triggering operation on the mode-switching interaction element, when no song accompaniment exists for the target song, prompt information indicating that no song accompaniment exists is displayed, and the original vocal of the target song continues to be played.

Further, the song accompaniment of the target song is played in the song singing mode from song progress that is of the target song and that is indicated by the original vocal.

Further, a currently sung lyrics word is highlighted in the song accompaniment of the target song in the song singing mode.

In an exemplary embodiment, switching is performed from the song singing mode to the song listening mode in response to a triggering operation on the mode-switching interaction element in the song singing mode; and the original vocal of the target song is played in the song listening mode from the song progress that is of the target song and that is indicated by the song accompaniment.

In an exemplary embodiment, switching is performed in the song singing mode from the song singing mode to the song listening mode when silence duration of the target object meets a duration condition for indicating to abandon following the target song.

In an exemplary embodiment, switching is performed in the song singing mode from the song singing mode to the song listening mode when duration of a song singing voice of the target object meets a preset duration condition and speech recognition text of the song singing voice does not match lyrics of the target song.

Further, in the song listening mode, the original vocal of the target song is played from the song progress that is of the target song and that is indicated by the song accompaniment, and a currently sung lyrics sentence in the original vocal of the target song is highlighted.

In an exemplary embodiment, switching is performed, when the song accompaniment of the target song is played, from the song singing mode to the song listening mode in response to a trigger event for switching from the target song to another song; and an original vocal of the another song is played in the song listening mode.

In this exemplary embodiment, in the song listening mode, the original vocal of the target song is played by default, the mode-switching interaction element for switching a song mode by a user is displayed, and the lyrics of the target song are displayed.

Automatic switching of the song mode can be realized through continuous mouth shape following behavior of the user. In the song listening mode, when the target object exists in the computer vision field of view, and the first continuous mouth shape following behavior for the target song exists at the mouth of the target object, it may be preliminarily determined that an intention of the user to sing along to the song exists. In this case, the volume of the original vocal is reduced, to further subsequently confirm whether the intention of the user to sing along to the song exists. When the second continuous following behavior for the target song further exists after the first continuous mouth shape following behavior for the target song exists at the mouth of the target object in the computer vision field of view, it is determined again that the user needs to sing the song, and switching is automatically performed from the song listening mode to the song singing mode, so that the user does not need to manually adjust a song mode, thereby achieving flexible adjustment of the song mode.

In addition, automatic switching of the song mode can alternatively be implemented through a continuous voice following behavior of the user. When the first following voice of the target object indicates the first continuous voice following behavior for the target song, the first following voice includes the continuous tone matching at least part of the continuous melody of the target song, and the speech recognition text of the first following voice matches at least part of the lyrics of the target song, so that the matching of the continuous tone of the target song and the matching of the speech recognition text that are performed by the user can be used as a condition for reducing the volume of the original vocal, thereby preliminarily recognizing a singing along intention of the user. Based on the volume reduction, when the second following voice indicates the second continuous voice following behavior for the target song, the second following voice includes the continuous tone matching at least part of the continuous melody of the target song, and the speech recognition text of the second following voice matches at least part of the lyrics of the target song, so that the matching of the continuous tone of the target song and the matching of the speech recognition text that are performed by the user can be used as a condition for switching a song mode, thereby accurately determining mode switching, and flexibly adjusting switching from the song listening mode to the song singing mode.

When no song accompaniment exists for the target song, prompt information indicating that no song accompaniment exists is automatically displayed, to provide a prompt to the user that no accompaniment exists for the currently played song, and the original vocal of the target song continues to be played, so that there is no need to interrupt playing of the song in the prompt process, thereby providing a better music service.

In addition, the lyrics are highlighted sentence by sentence in the song listening mode, and the lyrics are highlighted word by word in the song singing mode, so that different lyrics display manners can be provided for the song singing mode and the song listening mode. In the song listening mode, a currently sung lyrics sentence in the original vocal of the target song is highlighted. In this way, a sung sentence of the lyrics can be highlighted when the user is in a song listening state, so that the user focuses on the currently sung lyrics sentence, and understands a meaning of the currently sung lyrics, thereby providing better music experience to the user. After switching is performed from the song listening mode to the song singing mode, a currently sung lyrics word in the song accompaniment of the target song is highlighted, so that the user can see the currently sung word, thereby avoiding poor music experience caused by user singing off beats, missing beats, forgetting words, or the like, and helping improve accuracy of singing of the user.

In the song singing mode, the song accompaniment of the target song is played from the song progress that is of the target song and that is indicated by the original vocal, so that current progress of the original vocal can be naturally transited to corresponding progress of the song accompaniment. In this way, a song mode can be switched at any playing progress at any time, making switching of the song mode and the song playing more flexible.

In an exemplary embodiment, an application scenario of a song playing method is provided, and is specifically applied to an in-vehicle terminal. A user plays a target song in a vehicle through a music application on the in-vehicle terminal, and performs mouth shape recognition and user voice recognition on any user in the vehicle at the same time, to determine whether the user hums a currently played target song, and if yes, reduce a volume of an original vocal of the target song. When it is detected that the user hums or has long humming duration for a plurality of times, switching is automatically performed from the song listening mode to the song singing mode. The song singing mode is an accompaniment mode, and refers to playing a song accompaniment of the target song. The application scenario includes four parts: input, recognition and conversion, and switching back, and processing of each part is as follows:

(1) Input. The input is mainly divided into a visual input and an auditory input, wherein the visual input depends on a camera and visual interaction recognition. An in-vehicle smart camera may recognize a contrast between a mouth shape of a user (to be specific, recognize a lip language) and a humming song through a facial recognition technology. The auditory input relies on a microphone. After receiving a speech of a user, a front-end signal processor performs echo cancellation and noise reduction processing. Through the foregoing two inputs, a system can recognize whether the user is singing, and confirm again singing information of the user through an identification technology after identifying that the user is singing.

(2) Recognition and conversion. After the singing information of the user is inputted, it may be recognized, through a humming song tune recognition technology, whether a song sung by the user matches a currently played song. The currently played song is a target song. When it is recognized that the song sung by the user matches the currently played song, in a song listening mode, when it is detected that the user continuously hums for duration greater than or equal to six seconds or that the user continuously hums three sentences of lyrics, a volume of an original vocal of the target song is reduced to 80%, and a volume of a song accompaniment remains unchanged. The volume of the original vocal of the target song is reduced to 40% when it is detected that the user continuously hums for duration greater than or equal to 12 seconds or that the user continuously hums six sentences. In the song listening mode, the lyrics of the target song are highlighted sentence by sentence. FIG. 6 is a schematic diagram of a lyrics interface of a song listening mode. A currently sung sentence of lyrics is highlighted.

When it is detected that a user continuously hums for duration greater than or equal to 18 seconds or the user continuously hums 9 sentences, an original vocal completely changes to a song accompaniment, and an interface function changes to a song singing mode. A lyrics interface of the song singing mode is shown in FIG. 7. The lyrics change from being sentence-to-sentence highlighted to being word-to-word highlighted, currently sung lyrics are highlighted, and song progress does not need to be started again, so that the song accompaniment is played from a time point at which a song mode is switched. In this way, the user does not need to wait for loading and does not need to start singing from the beginning of a target song.

(3) Switching back. In the song singing mode, when it is detected that continuous silence duration of the user is greater than or equal to six seconds or that three continuous sentences of lyrics are not sung, switching back to the song listening mode is automatically performed. In addition, when the song accompaniment of the target song ends in the song singing mode, switching back to the song listening mode is automatically performed when a next song starts.

In addition, the user may manually tap a mode-switching interaction element on a screen at any time for mode switching. The mode-switching interaction element is displayed as a song listening button in FIG. 6, and is displayed as a song singing button in FIG. 7.

In an exemplary embodiment, the song playing method may be applied to vehicle infotainment on various platforms, for example, vehicle infotainment on an Android platform. The vehicle infotainment is a short form of an in-vehicle infotainment product, for example, an in-vehicle terminal or a music application on the in-vehicle terminal, mounted in the vehicle. The vehicle infotainment can implement information communication between a person and a vehicle and between the vehicle and an outside world (for example, between vehicles).

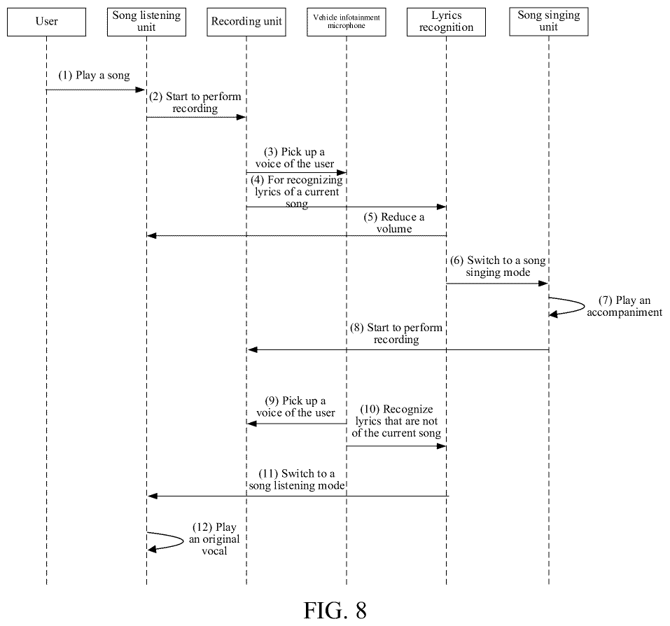

In an exemplary embodiment, the song playing method may be applied to the vehicle infotainment. When the method is applied to the vehicle infotainment, an application programming interface (API for short) corresponding to a music player side configured for playing an original vocal of a target song and an API of an accompaniment music machine side configured for playing a song accompaniment need to be invoked. In different song modes, a corresponding API and player need to be used. FIG. 8 is a sequence diagram of a song playing method according to the exemplary embodiments.

(1) Request a server or a local cache in a song listening mode when a current song including an original vocal and a song accompaniment is played, to obtain lyrics of the current song, wherein the current song is a target song.

(2) Start recording through a recording unit while the current song is played.

(3) The recording unit picks up a voice of a user through a vehicle infotainment microphone, performs noise reduction and compression on a recorded audio stream, uploads the recorded audio stream to the server in real time, and performs speech recognition, to obtain corresponding speech recognition text.

(4) Compare the speech recognition text with lyrics of the currently played song after the speech recognition text is received.

(5) If a comparison result meets humming of three sentences or duration greater than six seconds, reduce a volume of the music player, and repeat (3) and (4); and when the comparison result meets humming of six sentences or duration greater than 12 seconds, continue to reduce the volume, and repeat (3) and (4).

(6) Enter a song singing mode when the comparison result meets humming of nine sentences or duration greater than 18 seconds.

(7) Pull an accompaniment resource, stop playing the original vocal, and start to play the song accompaniment.

(8) Repeat (3) to continue to recognize a voice of the user.

(9) Pick up the voice of the user, perform noise reduction and compression on a recorded audio stream, and upload the recorded audio stream to the server in real time, to perform speech recognition.

(10) Perform (11) if there are six seconds without humming, or hummed text is inconsistent with current lyrics by 3 lines.

(11) Switch to the song listening mode.

(12) Play the song accompaniment in the song listening mode, and repeat (1).

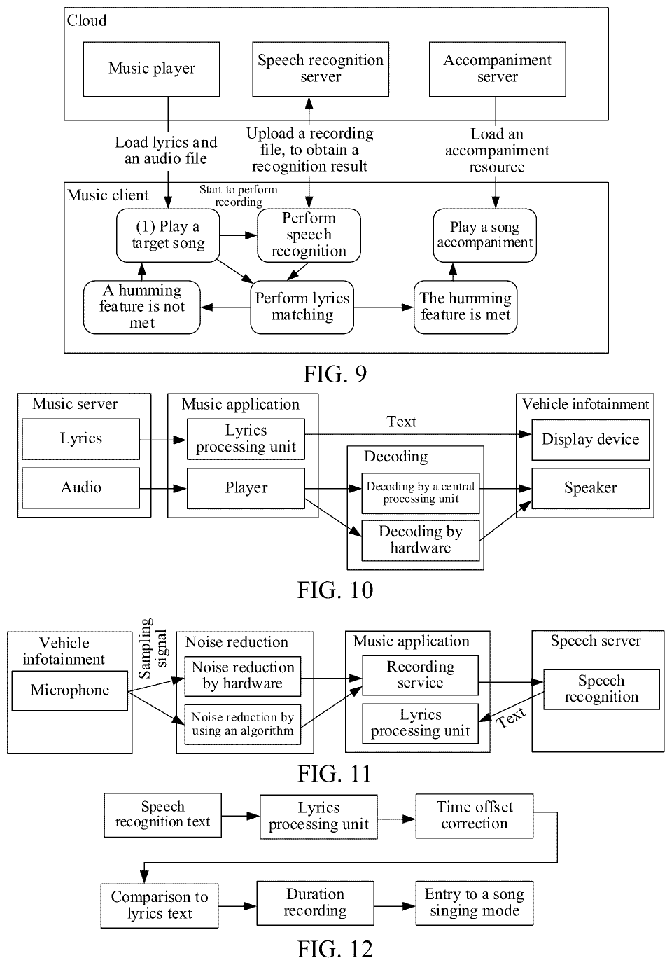

FIG. 9 shows an overall architecture and a procedure. A music server, a speech recognition server, and an accompaniment server are deployed on a cloud. The music application is a music client, and the music client is deployed on an in-vehicle terminal. When a target song needs to be played, the music client loads lyrics and an audio file from the music server for playing, and displays the song. Recording is started when the target song is played, and an obtained recording file is transmitted to the speech server for automatic speech recognition (ASR for short). Then, recognized text is obtained. Whether to enter a humming mode is determined based on a comparison between the recognized text and the lyrics, recorded recording duration, and the foregoing determining conditions. If matching is not implemented, a humming feature is not met. In this case, the original vocal of the target song continues to be played. If matching of the lyrics is implemented, the humming feature is met. In this case, the accompaniment mode is entered, and a song accompaniment resource of the target song is downloaded from the accompaniment server for playing.

As shown in FIG. 10, when music is played, a music client downloads a lyrics file in a format of Irc (lyric, an extension of the lyrics file) and an audio file in a format of m4a (an extension of a file of the MPEG-4 audio standard)/free lossless audio codec (flac) from a music server, and parses the lyrics in the format of Ire into text displayed line by line by time. The lyrics file is transferred to a lyrics processing unit of a music application, and the lyrics processing unit transfers the lyrics file to an in-vehicle head-up display device of the vehicle infotainment for display. In addition, a uniform resource identifier (URI) of the audio file is transferred to a player of the music application. After downloading an audio file resource, the player decodes the audio resource into a pulse code modulation (PCM) byte stream through decoding hardware of the vehicle infotainment or a central processing unit (CPU), and then transfers the PCM byte stream to a speaker AudioTrack of the vehicle infotainment system. Then, a sound is played by the vehicle infotainment speaker.

As shown in FIG. 11, during recording, a sound is detected through a microphone of a vehicle infotainment system, to obtain an audio data stream in a PCM format. In addition, hardware or an algorithm is used to filter out a sound of a vehicle infotainment speaker and surrounding noises. A PCM byte stream after being noise reduced is transmitted to a speech server to perform automatic speech recognition, and then recognized text is obtained.

Humming is confirmed. Whether to enter an accompaniment mode is determined based on a comparison between the recognized text and lyrics, recorded recording duration, and the foregoing determining conditions, as shown in FIG. 12.

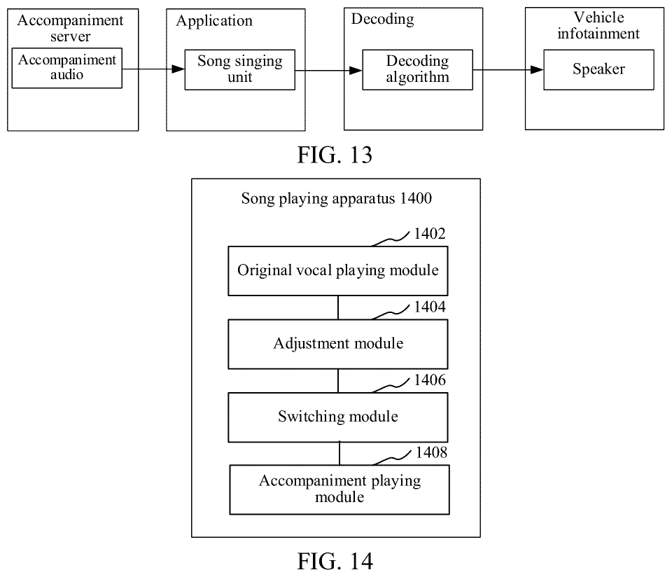

As shown in FIG. 13, an accompaniment mode is entered, a song accompaniment resource is downloaded from an accompaniment server and decoded by using a decoding algorithm dedicated to an accompaniment, and a PCM stream obtained through decoding is transmitted to a speaker AudioTrack of a vehicle infotainment system for playing.

In this exemplary embodiment, functions of a song listening mode and a song singing mode are integrated, and the functions of the song listening mode and the song singing mode are combined into one music application. In this way, occupation of system storage space can be reduced, costs of test verification can be reduced, and experience of switching between the song listening mode and the song singing mode can be effectively improved.

Although the operations in the flowcharts of the exemplary embodiments described above are displayed in sequence as indicated by arrows, these operations are not necessarily performed in sequence as indicated by arrows. Unless explicitly stated herein, the execution of these operations is not strictly limited in sequence, and these operations may be executed in other sequences. Moreover, at least some of the operations in the flowcharts of the exemplary embodiments may include a plurality of operations or a plurality of stages. The operations or stages are not necessarily performed at the same moment but may be performed at different moments. Execution of the operations or stages is not necessarily sequentially performed, but may be performed alternately with other operations or at least some of operations or stages of other operations.

Based on the same inventive idea, an exemplary embodiment of this disclosure further provides a song playing apparatus configured for implementing the foregoing song playing method. An implementation solution to the problem provided by the apparatus is similar to the implementation solution recorded in the foregoing method. Therefore, for specific limitations in one or more exemplary embodiments of the song playing apparatus provided below, refer to the limitations on the song playing method above.

In an exemplary embodiment, as shown in FIG. 14, a song playing apparatus 1400 is provided and includes: an original vocal playing module 1402, an adjustment module 1404, a switching module 1406, and an accompaniment playing module 1408.

The original vocal playing module 1402 is configured for playing an original vocal of a target song in a song listening mode.

The adjustment module 1404 is configured for reducing a volume of the original vocal in response to a first continuous following behavior for the target song. The first continuous following behavior is a continuous following behavior made with playing progress of the target song.

The switching module 1406 is configured for switching, in response to a second continuous following behavior after the first continuous following behavior, from a song listening mode to a song singing mode. The second continuous following behavior is different from the first continuous following behavior, and is a continuous following behavior that is made with the playing progress of the target song and that is generated after the first continuous following behavior.

The accompaniment playing module 1408 is configured for playing, in the song singing mode, a song accompaniment of the target song from song progress that is of the target song and that is indicated by the original vocal.

In this exemplary embodiment, the original vocal of the target song is played in the song listening mode, and the volume of the original vocal is reduced in response to the first continuous following behavior for the target song. An intention of the user to sing the song can be recognized based on the continuous following behavior made by the user with playing progress of the target song, to automatically reduce the volume of the original vocal, so that the continuous following behavior of the user is not covered by the original vocal. In this way, the user can hear a singing voice of the user, and this is conducive to further identification and confirmation of the continuous following behavior of the user. Switching is performed from the song listening mode to the song singing mode in response to the second continuous following behavior after the first continuous following behavior. The intention of the user to sing the song can be further confirmed based on the continuous following behavior that is made with the playing progress of the target song and that is generated by the user after the first continuous following behavior, so that the song is automatically and accurately adjusted from the song listening mode to the song singing mode, thereby achieving flexible adjustment and smooth switching of the song mode. In the song singing mode, the song accompaniment of the target song is played from the song progress that is of the target song and that is indicated by the original vocal, so that current progress of the original vocal can be naturally transited to corresponding progress of the song accompaniment. In this way, a song mode can be switched at any playing progress at any time and playing can be started from the same progress, making the song playing more flexible.

In an exemplary embodiment, the adjustment module 1404 is further configured for reducing the volume of the original vocal in the song listening mode when a target object exists in a computer vision field of view and a first continuous mouth shape following behavior for the target song exists at a mouth of the target object.

The switching module 1406 is further configured for switching, after the first continuous mouth shape following behavior, from the song listening mode to the song singing mode when a second continuous mouth shape following behavior for the target song exists at the mouth of the target object.

In this exemplary embodiment, the first continuous following behavior includes the first continuous mouth shape following behavior, and the second continuous following behavior includes the second continuous mouth shape following behavior, so that the volume of the original vocal can be automatically reduced based on continuous mouth shape following of the song by the user, and a song mode can be automatically switched based on a plurality of times of continuous mouth shape following. In the song listening mode, when the target object exists in the computer vision field of view, and the first continuous mouth shape following behavior for the target song exists at the mouth of the target object, it may be preliminarily determined that an intention of the user to sing along to the song exists. In this case, the volume of the original vocal is reduced, to further subsequently confirm whether the intention of the user to sing along to the song exists. After the first continuous mouth shape following behavior, when the second continuous following behavior for the target song further exists at the mouth of the target object, it is determined again that the user needs to sing the song. In this case, switching is automatically performed from the song listening mode to the song singing mode, so that the user does not need to manually adjust the song mode, thereby achieving flexible adjustment of the song mode.

In an exemplary embodiment, the apparatus further includes a detection module. The detection module is further configured for performing target object detection in the song listening mode; and performing continuous mouth shape detection on the mouth of the target object when the target object is detected in the computer vision field of view, to obtain a first continuous mouth shape of the target object.

The adjustment module 1404 is further configured for reducing the volume of the original vocal when the first continuous mouth shape matches at least part of mouth shapes of a singing object of the original vocal, which represents that the first continuous mouth shape following behavior for the target song exists at the mouth of the target object.

In this exemplary embodiment, target object detection is performed in the song listening mode, to determine whether the target object exists. When the target object exists, continuous mouth shape detection is performed on the mouth of the target object, to determine whether the continuous mouth shape of the target object is the same as at least part of the mouth shapes of the singing object of the original vocal. If yes, the user is singing along to the song. In this case, it may be preliminarily determined that an intention of the user to sing along to the song exists. In this case, the volume of the original vocal is reduced, so that the user can hear a singing voice of the user, and this helps subsequently further confirm whether the intention of the user to sing along to the song exists.

In an exemplary embodiment, the switching module 1406 is further configured for performing continuous mouth shape detection on the mouth of the target object after the first continuous mouth shape following behavior, to obtain a second continuous mouth shape of the target object; and switching from the song listening mode to the song singing mode when the second continuous mouth shape matches at least part of mouth shapes of the singing object of the original vocal, which represents that the second continuous mouth shape following behavior for the target song exists at the mouth of the target object.

In this exemplary embodiment, whether the first continuous mouth shape of the target object is the same as at least part of the mouth shapes of the singing object of the original vocal is used to preliminarily determine whether the user is singing along to the song. In this case, the volume of the original vocal may be reduced when it is preliminarily determined that the intention of the user to sing along to the song exists, so as to further subsequently confirm whether an intention of the user to sing exists. After matching of the first continuous mouth shape, if a case in which a continuous mouth shape of the user is the same as at least part of the mouth shapes of the original vocal further exists, it may be determined again that the user needs to sing the song. In this case, switching is automatically performed from the song listening mode to the song singing mode, so that the user does not need to manually adjust the song modes, thereby achieving flexible adjustment of the song modes. In addition, whether the user is singing along to the song is determined through a plurality of times of continuous mouth shape detection, so that the determining is more accurate, thereby improving accuracy of song switching.

In an exemplary embodiment, the first continuous following behavior includes a first continuous voice following behavior, and the second continuous following behavior includes a second continuous voice following behavior. The adjustment module 1404 is further configured for reducing the volume of the original vocal in the song listening mode when a first following voice of the target object exists and the first following voice indicates the first continuous voice following behavior for the target song.

The switching module 1406 is configured for switching from the song listening mode to the song singing mode when a second following voice of the target object after the first following voice exists and the second following voice indicates the second continuous voice following behavior for the target song.

In this exemplary embodiment, the first continuous following behavior includes the first continuous voice following behavior, and the second continuous following behavior includes the second continuous voice following behavior, so that volume reduction of the original vocal and flexible switching of the song mode can be automatically implemented based on a plurality of continuous voice following behaviors of the song by the user. In the song listening mode, when the first following voice of the target object exists and the first following voice indicates the first continuous voice following behavior for the target song, it represents that the user is singing along to the played target song. In this case, the volume of the original vocal is reduced, so that the user can hear a singing along voice of the user, and further confirm, based on the singing along, whether to switch to the song singing mode is required. When the second following voice of the target object after the first following voice exists and the second following voice indicates the second continuous following behavior for the target song, it represents that the user has a plurality of times of continuous singing along to the target song, which means that the user expects to singing along to the song. In this case, switching is automatically performed from the song listening mode to the song singing mode, so that the song mode can be flexibly adjusted based on the singing along of the user.

In an exemplary embodiment, when the first following voice indicates the first continuous voice following behavior for the target song, the first following voice includes a continuous tone matching at least part of a continuous melody of the target song, and speech recognition text of the first following voice matches at least part of lyrics of the target song; and when the second following voice indicates the second continuous voice following behavior for the target song, the second following voice includes a continuous tone matching at least part of a continuous melody of the target song, and speech recognition text of the second following voice matches at least part of lyrics of the target song.

In this exemplary embodiment, when the first following voice indicates the first continuous voice following behavior for the target song, the first following voice includes the continuous tone matching at least part of the continuous melody of the target song, and the speech recognition text of the first following voice matches at least part of the lyrics of the target song, so that the matching of the continuous tone of the target song and the matching of the speech recognition text that are performed by the user can be used as a condition for reducing the volume of the original vocal, thereby preliminarily recognizing a singing along intention of the user. Based on the volume reduction, when the second following voice indicates the second continuous voice following behavior for the target song, the second following voice includes the continuous tone matching at least part of the continuous melody of the target song, and the speech recognition text of the second following voice matches at least part of the lyrics of the target song, so that the matching of the continuous tone of the target song and the matching of the speech recognition text that are performed by the user can be used as a condition for switching a song mode, thereby accurately determining mode switching, and flexibly adjusting switching from the song listening mode to the song singing mode.

In an exemplary embodiment, duration of the first following voice meets a first duration condition for the first continuous voice following behavior, and duration of the second following voice meets a second duration condition for the second continuous voice following behavior.

In this exemplary embodiment, when the duration of the first following voice meets the first duration condition for the first continuous voice following behavior, the singing along duration of the user for the target song meets a preset condition for reducing the volume. In this case, it means that an intention of the user to sing exists. In this case, the volume of the original vocal may be automatically reduced based on the singing along duration of the user, so that the user can hear a singing along voice of the user. When the duration of the second following voice meets the second duration condition for the second continuous voice following behavior, the singing along duration of the user for the target song already meets a preset condition for mode switching. In this case, switching may be automatically performed from the song listening mode to the song singing mode based on the singing along duration of the user, to flexibly implement real-time switching of song modes.

In an exemplary embodiment, the detection module is further configured for performing target object detection in the song listening mode; and obtaining the first following voice of the target object when the target object is detected in a computer vision field of view.

The adjustment module 1404 is further configured for reducing the volume of the original vocal when the first following voice matches at least part of continuous singing voices of the target song, which represents that the first following voice indicates the first continuous voice following behavior for the target song.

In this exemplary embodiment, target object detection is performed in the song listening mode, to determine whether the target object exists. If the target object exists, the first following voice of the target object is detected, to determine whether the target object is singing along to the original vocal. When the first following voice is the same as at least part of the continuous singing voice of the target song, the user is singing along to the played target song. In this case, the volume of the original vocal is reduced, so that the user can hear a singing along voice of the user, and further confirm, based on the singing along, whether to switch to the song singing mode is required.

In an exemplary embodiment, the detection module is further configured for obtaining the second following voice of the target object after the first following voice after the existence of the first following voice of the target object indicates the first continuous voice following behavior for the target song.

The switching module 1406 is further configured for switching from the song listening mode to the song singing mode when the second following voice matches at least part of continuous singing voices of the target song, which represents that the second following voice indicates the second continuous voice following behavior for the target song.

In this exemplary embodiment, target object detection is performed in the song listening mode, to determine whether the target object exists. If the target object exists, the first following voice of the target object is detected, to determine whether the target object is singing along to the original vocal. When the first following voice is the same as at least part of the continuous singing voice of the target song, the user is singing along to the played target song. In this case, the volume of the original vocal is reduced, so that the user can hear a singing along voice of the user, and further confirm, based on the singing along, whether to switch to the song singing mode is required. When the second following voice of the target object after the first following voice exists, and the second following voice is the same as at least part of a continuous singing voice of the target song, it represents that the user has a plurality of times of continuous singing along to the target song, which means that the user expects to sing the song. In this case, switching is automatically performed from the song listening mode to the song singing mode, so that the song mode can be flexibly adjusted based on the singing along of the user.

In an exemplary embodiment, the apparatus further includes a speech recognition module. The speech recognition module is configured for performing speech recognition on the first following voice, to obtain corresponding first speech recognition text.

The adjustment module 1404 is further configured for reducing the volume of the original vocal when a continuous tone in the first following voice matches at least part of a continuous melody of the target song and the first speech recognition text matches at least part of lyrics of the target song, which represents that the first following voice indicates the first continuous voice following behavior for the target song.

In this exemplary embodiment, target object detection is performed in the song listening mode, to determine whether the target object exists. If the target object exists, the first following voice of the target object is detected and converted into the first speech recognition text. When the continuous tone in the first following voice matches at least part of the continuous melody of the target song and the first speech recognition text matches at least part of the lyrics of the target song, it is determined that the first following voice indicates the first continuous voice following behavior for the target song, so that the matching of the continuous tone of the target song and the matching of the speech recognition text that are performed by the user can be used as a condition for reducing the volume of the original vocal, thereby preliminarily recognizing a singing along intention of the user.

In an exemplary embodiment, the speech recognition module is further configured for performing speech recognition on the second following voice, to obtain corresponding second speech recognition text.

The switching module 1406 is further configured for switching from the song listening mode to the song singing mode when a continuous tone in the second following voice matches at least part of a continuous melody of the target song and the second speech recognition text matches at least part of lyrics of the target song, which represents that the second following voice indicates the second continuous voice following behavior for the target song.

In this exemplary embodiment, the volume of the original vocal is reduced after it is determined that the first following voice indicates the first continuous voice following behavior for the target song. Speech recognition is performed on the second following voice based on volume reduction, to obtain the corresponding second speech recognition text. When the continuous tone in the second following voice matches at least part of the continuous melody of the target song and the second speech recognition text matches at least part of the lyrics of the target song, it is determined that the second following voice indicates the second continuous voice following behavior for the target song, so that matching of the continuous tone of the target song and matching of the speech recognition text that are performed by the user can be used as a condition for switching of a song mode, thereby accurately determining mode switching and flexibly adjusting switching from the song listening mode to the song singing mode. In addition, the determining is performed based on two conditions: continuous tone matching and lyrics matching, so that determining on a singing along behavior of the user is more accurate.

In an exemplary embodiment, the detection module is further configured for obtaining, when the target object is detected in the computer vision field of view, first audio obtained by performing audio detection on the target object, the first following voice of the target object being recorded in the first audio.

The speech recognition module is further configured for transmitting first intermediate audio obtained by locally performing noise reduction and compression processing on the first audio to a server; and receiving the first speech recognition text corresponding to the first following voice fed back by the server based on the first intermediate audio.

In this exemplary embodiment, the first audio is detected and transmitted, after being locally noise reduced and compressed, to the server for speech recognition, to obtain the first following voice and the corresponding speech recognition text, so that it can be determined whether the first following voice includes the continuous tone matching at least part of the continuous melody of the target song, and it can be determined whether the speech recognition text of the first following voice matches at least part of the lyrics of the target song. In this way, whether matching of the tone of the first following voice is implemented and whether matching of the speech recognition text is implemented are used as a condition for reducing the volume of the original vocal, thereby accurately recognizing whether a sing along intention of the user exists.

In an exemplary embodiment, the detection module is further configured for obtaining, after the existence of the first following voice of the target object indicates the first continuous voice following behavior for the target song, second audio obtained by performing audio detection on the target object after the first audio is detected, the second following voice of the target object being recorded in the second audio.

The speech recognition module is further configured for transmitting second intermediate audio obtained by locally performing noise reduction and compression processing on the second audio to the server; and receiving the second speech recognition text corresponding to the second following voice fed back by the server based on the second intermediate audio.

In this exemplary embodiment, whether matching of the tone of the first following voice is implemented and whether matching of the speech recognition text is implemented are used as a condition for reducing the volume of the original vocal, to accurately recognize whether a singing intention of the user exists. After the volume is reduced, the second audio is detected and transmitted, after being locally noise reduced and compressed, to the server for speech recognition, to obtain the second following voice and the corresponding speech recognition text, so that it can be determined whether the second following voice includes the continuous tone matching at least part of the continuous melody of the target song, and it can be determined whether the speech recognition text of the second following voice matches at least part of the lyrics of the target song. In this way, whether matching of the tone of the second following voice is implemented and whether matching of the speech recognition text is implemented are used as a condition for mode switching, specifically as a condition for switching from the song listening mode to the song singing mode, so that it can be accurately determined whether mode switching needs to be performed, thereby accurately switching the song mode.

In an exemplary embodiment, the adjustment module 1404 is further configured for reducing, in response to each of following sub-behaviors in the first continuous following behavior for the target song, each current volume of the original vocal until the volume of the original vocal reaches a minimum volume in response to the first continuous following behavior after a last following sub-behavior.

In this exemplary embodiment, the first continuous following behavior includes at least two following sub-behaviors. Each time a following sub-behavior of the user for the song is detected, a current playing volume of the original vocal is reduced, so that the volume of the original vocal is automatically reduced at least twice until the volume of the original vocal reaches the minimum volume in response to the first continuous following behavior after a last following sub-behavior. A plurality of automatic volume reduction conditions are set, so that the volume reduction conditions are more refined and meet user needs more.

In an exemplary embodiment, the apparatus further includes a display module. The display module is configured to display a mode-switching interaction element.

The switching module 1406 is further configured for switching, in response to a triggering operation on the mode-switching interaction element in the song listening mode, from the song listening mode to the song singing mode.

The accompaniment playing module 1408 is further configured for playing, in the song singing mode, a song accompaniment of the target song from song progress that is of the target song and that is indicated by the original vocal.

In this exemplary embodiment, the mode-switching interaction element is displayed regardless of playing the original vocal or the song accompaniment of the target song, to provide an option to manually switch the song mode. In the song listening mode, the user may choose to manually trigger the mode-switching interaction element, to perform manual switching from the song listening mode to the song singing mode, thereby providing options for manual switching and automatic song mode switching. More comprehensive functions are implemented. In the song singing mode, the song accompaniment of the target song is played from the song progress that is of the target song and that is indicated by the original vocal, so that the current progress of the original vocal can be naturally transitioned to the corresponding progress of the song accompaniment, thereby achieving smooth switching of the song mode.

In an exemplary embodiment, the apparatus further includes a display module. The display module is configured to display a mode-switching interaction element.

The switching module 1406 is further configured for switching from the song singing mode to the song listening mode in response to a triggering operation on the mode-switching interaction element in the song singing mode.

The original vocal playing module 1402 is further configured for playing, in the song listening mode, the original vocal of the target song from song progress that is of the target song and that is indicated by the song accompaniment.

In this exemplary embodiment, the mode-switching interaction element is displayed regardless of playing the original vocal or the song accompaniment of the target song, to provide an option to manually switch the song mode. In the song singing mode, the user may choose to manually trigger the mode-switching interaction element, to perform manual switching from the song singing mode to the song listening mode, thereby providing options for manual switching and automatic song mode switching. Selection manners are more diverse. In the song listening mode, the original vocal of the target song is played from the song progress that is of the target song and that is indicated by the song accompaniment, so that the current progress of the song accompaniment can be naturally transitioned to the corresponding progress of the original vocal, and the original vocal does not need to be played from the beginning, thereby effectively achieving smooth switching of the song mode.

In an exemplary embodiment, the switching module 1406 is further configured for switching, in the song singing mode, from the song singing mode to the song listening mode when silence duration of the target object meets a duration condition for indicating to abandon following the target song.

The original vocal playing module 1402 is further configured for playing, in the song listening mode, the original vocal of the target song from song progress that is of the target song and that is indicated by the song accompaniment.

In this exemplary embodiment, in the song singing mode, when the silence duration of the target object meets the duration condition for indicating to abandon following the target song, the user does not have an intention to continue singing, to be specific, the user does not expect to continue singing the song. In this case, the target song is automatically and accurately switched from the song singing mode to the song listening mode, so that the song mode can be flexibly adjusted and smoothly switched. In the song listening mode, the original vocal of the target song is played from the song progress that is of the target song and that is indicated by the song accompaniment, so that the current progress of the song accompaniment can be naturally transitioned to the corresponding progress of the original vocal, and the original vocal does not need to be played from the beginning, thereby effectively achieving smooth transition between the song accompaniment and the original vocal.

In an exemplary embodiment, the switching module 1406 is further configured for switching, in the song singing mode, from the song singing mode to the song listening mode when duration of a song singing voice of the target object meets a preset duration condition and speech recognition text of the song singing voice does not match lyrics of the target song.

In this exemplary embodiment, in the song singing mode, when the duration of the song singing voice of the target object meets the preset duration condition, and the speech recognition text of the song singing voice does not match the lyrics of the target song, it means that the user does not expect to sing the currently played song or is unfamiliar with the currently played song. In this case, switching is performed from the song singing mode to the song listening mode. In this way, the duration of the song singing voice of the user and the speech recognition text of the song singing voice can be used as two determining conditions for switching from the song singing mode to the song listening mode, thereby further improving determining accuracy of song mode switching.

In an exemplary embodiment, the switching module 1406 is further configured for switching from the song listening mode to the song singing mode in response to the second continuous following behavior after the first continuous following behavior when the song accompaniment exists for the target song.

The original vocal playing module 1402 is further configured for displaying, in response to the second continuous following behavior after the first continuous following behavior when no song accompaniment exists for the target song, prompt information indicating that no song accompaniment exists, and continuing to play the original vocal of the target song.

In this exemplary embodiment, whether the song accompaniment exists for the target song is determined in response to the second continuous following behavior after the first continuous following behavior, and if yes, switching is automatically performed from the song listening mode to the song singing mode, thereby achieving flexible adjustment of the song mode. When no song accompaniment exists for the target song, prompt information indicating that no song accompaniment exists is automatically displayed, to provide a prompt to the user that no accompaniment exists for the currently played song, and the original vocal of the target song continues to be played, so that there is no need to interrupt playing of the song in the prompt process, thereby providing a better music service.

In an exemplary embodiment, the apparatus further includes a prompt module. The prompt module is configured for displaying, in the song listening mode, original vocal weakening prompt information for the target song when a quantity of playing times of the target song meets a familiar song determining condition of the target object for the target song, the original vocal weakening prompt information being configured for indicating to trigger original vocal weakening processing for the target song, and the original vocal weakening processing including at least one of reducing the volume of the original vocal or switching to the song singing mode.

In this exemplary embodiment, in the song listening mode, when the quantity of playing times of the target song meets the familiar song determining condition of the target object for the target song, the user is relatively familiar with the currently played song. In this case, the original vocal weakening prompt information for the target song is automatically displayed, to provide a prompt to the user whether to reduce the volume of the original vocal or to switch to the song singing mode is required. In this way, a proper intelligent prompt can be provided based on songs frequently listened to by the user, so that song playing is more flexible.

In an exemplary embodiment, the apparatus further includes a display module. The display module is configured for highlighting, in the song listening mode, a currently sung lyrics sentence in the original vocal of the target song; and highlighting a currently sung lyrics word in the song accompaniment of the target song after switching from the song listening mode to the song singing mode.

In this exemplary embodiment, the lyrics are highlighted sentence by sentence and the lyrics are highlighted word by word, so that lyrics display manners in the song singing mode and the song listening mode can be effectively distinguished. In addition, in the song listening mode, a currently sung lyrics sentence in the original vocal of the target song is highlighted. In this way, a sung sentence of the lyrics can be highlighted when the user is in a song listening state, so that the user focuses on the currently sung lyrics sentence, and understands a meaning of the currently sung lyrics, thereby providing better music experience to the user. After switching is performed from the song listening mode to the song singing mode, a currently sung lyrics word in the song accompaniment of the target song is highlighted, so that the user can see the currently sung word, thereby avoiding poor music experience caused by user singing off beats, missing beats, forgetting words, or the like, and helping improve accuracy of singing of the user.

In an exemplary embodiment, the switching module 1406 is further configured for switching, when the song accompaniment of the target song is played, from the song singing mode to the song listening mode in response to a trigger event for switching from the target song to another song.

The original vocal playing module 1402 is further configured for playing an original vocal of the another song in the song listening mode.

In this exemplary embodiment, when the song accompaniment of the target song is played, switching is performed from the song singing mode to the song listening mode in response to the trigger event for switching from the target song to the another song, so that during playing of a current song, a song to be played can be switched at any time, and a song mode is automatically switched based on song switching, so that the song mode can be flexibly switched. The original vocal of the another song is played in the song listening mode, effectively satisfying song listening needs of different users.

In an exemplary embodiment, the song playing method is performed by an in-vehicle terminal, and the apparatus further includes a display module. The display module is configured for connecting the in-vehicle terminal and an in-vehicle head-up display device in response to a lyrics projection event of the target song; and projecting the lyrics of the target song from the in-vehicle terminal to the in-vehicle head-up display device for display.

In this exemplary embodiment, the song playing method is performed by the in-vehicle terminal, and the song can be automatically and accurately adjusted from the song listening mode to the song singing mode based on a plurality of times of following behaviors of the user, so that smooth switching between the song listening mode and the song singing mode can be implemented in an in-vehicle scenario, without a manual operation of the user, thereby avoiding a driving safety risk caused by an active operation of the user. In addition, in the song singing mode, the song accompaniment of the target song is played from the song progress that is of the target song and that is indicated by the original vocal, so that current progress of the original vocal can be naturally transited to corresponding progress of the song accompaniment. In this way, a song mode can be switched at any playing progress at any time, making switching of the song mode and the song playing in the in-vehicle scenario more flexible. In response to the lyrics projection event of the target song, the in-vehicle terminal and the in-vehicle head-up display device are connected. The in-vehicle head-up display device may project information such as a current speed per hour and navigation onto a windscreen to form an image, and the lyrics of the target song are displayed through the in-vehicle head-up display device, so that a driver can view lyrics information without turning or lowering the head of the driver, a driving safety risk caused by an active operation of the user is avoided, and the user is fully enjoyable to song consumption in a driving environment.

Various modules in the foregoing song playing apparatus may be implemented entirely or partially through software, hardware, or a combination thereof. Each of the foregoing modules may be embedded in or independent of a processor in a computer device in the form of hardware, or may be stored in a memory in the computer device in the form of software to enable the processor to conveniently call and perform operations corresponding to each of the foregoing modules.

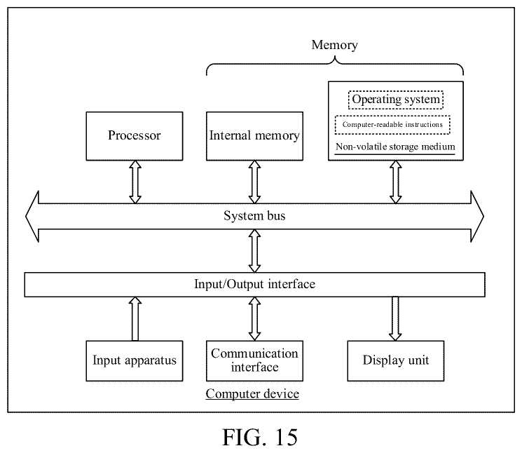

In an exemplary embodiment, a computer device is provided. The computer device may be a terminal, and a diagram of an internal structure thereof may be shown in FIG. 15. The computer device includes a processor, a memory, an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured for providing computing and control capabilities. The memory of the computer device includes a non-volatile storage medium and an internal memory. The non-volatile storage medium stores an operating system, and computer-readable instructions. The internal memory provides an environment for operations of the operating system and the computer-readable instructions in the non-volatile storage medium. The input/output interface of the computer device is configured for exchanging information between the processor and an external device. The communication interface of the computer device is configured for communicating with an external terminal in a wired or wireless manner. The wireless manner may be implemented through Wi-Fi, a mobile cellular network, near field communication (NFC), or another technology. The computer-readable instructions are executed by the processor to implement a song playing method. The display unit of the computer device may be configured for forming a visually visible screen and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, a mouse or the like.

A person skilled in the art may understand that, the structure shown in FIG. 15 is merely a block diagram of a partial structure related to a solution in this disclosure, and does not constitute a limitation to the computer device to which the solution in this disclosure is applied. Specifically, the computer device may include more components or fewer components than those shown in the figure, or some components may be combined, or a different component deployment may be used.

In an exemplary embodiment, a computer device is further provided, and includes a memory and one or more processors. The memory stores computer-readable instructions. The computer-readable instructions, when executed by the processor, cause the processor to perform the operations of the foregoing method embodiments.

In an exemplary embodiment, one or more non-volatile readable storage mediums storing computer-readable instructions are provided, and have computer-readable instructions stored therein. The computer-readable instructions, when executed by a processor, implement the operations in the foregoing method embodiments.

In an exemplary embodiment, a computer program product is provided. The computer program product includes computer-readable instructions. The computer-readable instructions, when executed by one or more processors, cause the one or more processors to perform the operations in the foregoing method embodiments.

User information (including but not limited to user equipment information, user personal information, and the like) and data (including but not limited to data for analysis, stored data, displayed data, and the like) in this disclosure are all information and data that are authorized by a user or fully authorized by all parties, and collection, use, and processing of relevant data need to comply with relevant laws, regulations, and standards of relevant countries and regions.

A person of ordinary skill in the art may understand that all or some of the procedures of the methods in the foregoing embodiments may be implemented by a computer-readable instruction instructing relevant hardware. The computer-readable instruction may be stored in a non-volatile computer-readable storage medium. When the computer-readable instruction is executed, the procedures of the foregoing method embodiments may be included. Any reference to a memory, a database, or another medium used in the exemplary embodiments provided in this disclosure may include at least one of a non-volatile or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM) or an external cache. As an illustration rather than a limitation, the RAM is available in various forms, such as a static random access memory (SRAM) or a dynamic random access memory (DRAM). The database in the exemplary embodiments provided in this disclosure may include at least one of a relational database and a non-relational database. The non-relational database may include a blockchain-based distributed database, or the like, but is not limited thereto. The processor in the exemplary embodiments provided in this disclosure may be a general-purpose processor, a central processing unit, a graphics processor, a digital signal processor, a programmable logic device, a quantum computing-based data processing logic device, or the like, but is not limited thereto.

The technical features of the foregoing exemplary embodiments may be combined in different manners to form other embodiments. For brevity of description, not all possible combinations of the technical features in the foregoing exemplary embodiments are described. However, the combinations of these technical features shall be considered as falling within the scope recorded by this specification provided that no conflict exists.

The foregoing exemplary embodiments only show several implementations of this disclosure and are described in detail, but they are not to be construed as a limit to the patent scope of this disclosure. For a person of ordinary skill in the art, several transformations and improvements can be made without departing from the idea of this disclosure. These transformations and improvements belong to the protection scope of this application. Therefore, the protection scope of this application shall be subject to the appended claims.

What is claimed is:

1. A song playing method performed by a terminal comprising:
playing an original vocal of a target song in a song listening mode;
reducing a volume of the original vocal in response to a first continuous following behavior for the target song, the first continuous following behavior being a continuous following behavior made with playing progress of the target song;
switching from the song listening mode to a song singing mode in response to a second continuous following behavior after the first continuous following behavior, the second continuous following behavior being different from the first continuous following behavior, and being a continuous following behavior that is made with the playing progress of the target song and is generated after the first continuous following behavior; and
playing, in the song singing mode, a song accompaniment of the target song from song progress of the target song that is indicated by the original vocal.

2. The method according to claim 1, wherein
the first continuous following behavior comprises a first continuous mouth shape following behavior, and the second continuous following behavior comprises a second continuous mouth shape following behavior;
the reducing a volume of the original vocal in response to a first continuous following behavior for the target song comprises reducing the volume of the original vocal in the song listening mode when a target object exists in a computer vision field of view and the first continuous mouth shape following behavior for the target song exists at a mouth of the target object; and
the switching from the song listening mode to a song singing mode in response to a second continuous following behavior after the first continuous following behavior comprises switching from the song listening mode to the song singing mode when the second continuous mouth shape following behavior for the target song exists at the mouth of the target object after the first continuous mouth shape following behavior.

3. The method according to claim 2, wherein the reducing the volume of the original vocal in the song listening mode when a target object exists in a computer vision field of view and the first continuous mouth shape following behavior for the target song exists at a mouth of the target object comprises:
performing a target object detection in the song listening mode;
performing, when the target object is detected in the computer vision field of view, continuous mouth shape detection on the mouth of the target object, so as to obtain a first continuous mouth shape of the target object; and
reducing the volume of the original vocal when the first continuous mouth shape matches at least part of mouth shapes of a singing object of the original vocal, which represents that the first continuous mouth shape following behavior for the target song exists at the mouth of the target object.

4. The method according to claim 3, wherein the switching from the song listening mode to the song singing mode when the second continuous mouth shape following behavior for the target song exists at the mouth of the target object after the first continuous mouth shape following behavior comprises:
performing continuous mouth shape detection on the mouth of the target object after the first continuous mouth shape following behavior, so as to obtain a second continuous mouth shape of the target object; and
switching from the song listening mode to the song singing mode when the second continuous mouth shape matches at least part of the mouth shapes of the singing object of the original vocal, which represents that the second continuous mouth shape following behavior for the target song exists at the mouth of the target object.

5. The method according to claim 1, wherein
the first continuous following behavior comprises a first continuous voice following behavior, and the second continuous following behavior comprises a second continuous voice following behavior;
the reducing a volume of the original vocal in response to a first continuous following behavior for the target song comprises reducing the volume of the original vocal in the song listening mode when a first following voice of a target object exists and the first following voice indicates the first continuous voice following behavior for the target song; and
the switching from the song listening mode to a song singing mode in response to a second continuous following behavior after the first continuous following behavior comprises switching from the song listening mode to the song singing mode when a second following voice of the target object after the first following voice exists and the second following voice indicates the second continuous voice following behavior for the target song.

6. The method according to claim 5, wherein when the first following voice indicates the first continuous voice following behavior for the target song, the first following voice comprises a continuous tone matching at least part of a continuous melody of the target song, and speech recognition text of the first following voice matches at least part of lyrics of the target song; and
when the second following voice indicates the second continuous voice following behavior for the target song, the second following voice comprises a continuous tone matching at least part of a continuous melody of the target song, and speech recognition text of the second following voice matches at least part of lyrics of the target song.

7. The method according to claim 5, wherein the reducing the volume of the original vocal in the song listening mode when a first following voice of the target object exists and the first following voice indicates the first continuous voice following behavior for the target song comprises:
performing a target object detection in the song listening mode;
obtaining the first following voice of the target object when the target object is detected in a computer vision field of view; and
reducing the volume of the original vocal when the first following voice matches at least part of continuous singing voices of the target song, which represents that the first following voice indicates the first continuous voice following behavior for the target song.

8. The method according to claim 7, wherein the switching from the song listening mode to the song singing mode when a second following voice of the target object after the first following voice exists and the second following voice indicates the second continuous voice following behavior for the target song comprises:
obtaining the second following voice of the target object after the first following voice indicates the first continuous voice following behavior for the target song; and
switching from the song listening mode to the song singing mode when the second following voice matches at least part of continuous singing voices of the target song, which represents that the second following voice indicates the second continuous voice following behavior for the target song.

9. The method according to claim 8, wherein the reducing the volume of the original vocal when the first following voice matches at least part of continuous singing voices of the target song, which represents that the first following voice indicates the first continuous voice following behavior for the target song comprises:
performing speech recognition on the first following voice, so as to obtain corresponding first speech recognition text; and
reducing the volume of the original vocal when a continuous tone in the first following voice matches at least part of a continuous melody of the target song and the first speech recognition text matches at least part of lyrics of the target song, which represents that the first following voice indicates the first continuous voice following behavior for the target song; and
wherein the switching from the song listening mode to the song singing mode when the second following voice matches at least part of continuous singing voices of the target song, which represents that the second following voice indicates the second continuous voice following behavior for the target song comprises:
performing speech recognition on the second following voice, so as to obtain corresponding second speech recognition text; and
switching from the song listening mode to the song singing mode when a continuous tone in the second following voice matches at least part of a continuous melody of the target song and the second speech recognition text matches at least part of lyrics of the target song, which represents that the second following voice indicates the second continuous voice following behavior for the target song.

10. The method according to claim 9, wherein
the obtaining the first following voice of the target object when the target object is detected in a computer vision field of view comprises obtaining, when the target object is detected in the computer vision field of view, a first audio by performing audio detection on the target object, the first following voice of the target object being recorded in the first audio; and
the performing speech recognition on the first following voice, so as to obtain corresponding first speech recognition text comprises:
transmitting first intermediate audio obtained by locally performing noise reduction and compression processing on the first audio to a server; and
receiving the first speech recognition text corresponding to the first following voice fed back by the server based on the first intermediate audio.

11. The method according to claim 1, wherein the first continuous following behavior comprises at least two following sub-behaviors performed in sequence; and the reducing a volume of the original vocal in response to a first continuous following behavior for the target song comprises:
reducing, in response to each of the following sub-behaviors in the first continuous following behavior for the target song, each current volume of the original vocal until the volume of the original vocal reaches a minimum volume in response to the first continuous following behavior after a last following sub-behavior.

12. The method according to claim 1, wherein the method further comprises:
displaying a mode-switching interaction element;
switching, in response to a triggering operation on the mode-switching interaction element in the song listening mode, from the song listening mode to the song singing mode; and
playing, in the song singing mode, a song accompaniment of the target song from song progress of the target song that is indicated by the original vocal.

13. The method according to claim 1, wherein the method further comprises:
displaying a mode-switching interaction element;
switching, in response to a triggering operation on the mode-switching interaction element in the song singing mode, from the song singing mode to the song listening mode; and
playing, in the song listening mode, the original vocal of the target song from the song progress that is of the target song and that is indicated by the song accompaniment.

14. The method according to claim 1, wherein the method further comprises:
switching, in the song singing mode, from the song singing mode to the song listening mode when silence duration of the target object meets a duration condition for indicating to abandon following the target song, or when duration of a song singing voice of the target object meets a preset duration condition and speech recognition text of the song singing voice does not match lyrics of the target song; and
playing, in the song listening mode, the original vocal of the target song from the song progress of the target song that is indicated by the song accompaniment.

15. The method according to claim 1, wherein the switching from the song listening mode to a song singing mode in response to a second continuous following behavior after the first continuous following behavior comprises:
switching from the song listening mode to the song singing mode in response to the second continuous following behavior after the first continuous following behavior when the song accompaniment exists for the target song.

16. The method according to claim 15, wherein the method further comprises:
displaying, in response to the second continuous following behavior after the first continuous following behavior when no song accompaniment exists for the target song, prompt information indicating that no song accompaniment exists, and continuing to play the original vocal of the target song.

17. The method according to claim 1, wherein the method further comprises:
displaying, in the song listening mode, original vocal weakening prompt information for the target song when a quantity of playing times of the target song meets a familiar song determining condition of the target object for the target song, the original vocal weakening prompt information being configured for indicating to trigger original vocal weakening processing for the target song, and the original vocal weakening processing comprising at least one of reducing the volume of the original vocal or switching to the song singing mode.

18. The method according to claim 1, wherein the method further comprises:
highlighting a currently sung lyrics sentence in the original vocal of the target song in the song listening mode; and
highlighting a currently sung lyrics word in the song accompaniment of the target song after switching from the song listening mode to the song singing mode.

19. A song playing apparatus, the apparatus comprising:
an original vocal playing module configured for playing an original vocal of a target song in a song listening mode;
an adjustment module configured for reducing a volume of the original vocal in response to a first continuous following behavior for the target song;
a switching module configured for switching from the song listening mode to a song singing mode in response to a second continuous following behavior after the first continuous following behavior; and
an accompaniment playing module configured for playing, in the song singing mode, a song accompaniment of the target song from song progress of the target song that is indicated by the original vocal.

20. A computer device, comprising a memory and one or more processors, the memory storing computer-readable instructions, and the computer-readable instructions, when executed by the processor, causing the processor to perform the operations in the method according to claim 1.
